(19) United States
(12) Patent Application Publication
(10) Pub. No.: US 2024/0211745 A1
(43) Pub. Date: Jun. 27, 2024

(54) BISTABLE RESISTIVELY-COUPLED SYSTEM

(71) Applicant: UNIVERSITY OF ROCHESTER, Rochester, NY (US)

(72) Inventors: Michael Huang, Pittsford, NY (US); Zeljko Ignjatovic, Rochester, NY (US); Richard Afoakwa, Beltsville, MD (US); Uday Kumar Reddy Vengalam, Brighton, NY (US); Yiqiao Zhang, Rochester, NY (US)

(21) Appl. No.: 18/555,772

(22) PCT Filed: Apr. 15, 2022
(86) PCT No.: PCT/US22/25001

§ 371 Date: Oct. 17, 2023

Related U.S. Application Data
(60) Provisional application No. 63/176,247, filed on Apr. 17, 2021.

(51) Int. Cl. G06N 3/065; G06N 3/04; G06N 3/08

(52) U.S. Cl. CPC G06N 3/065; G06N 3/04; G06N 3/08

(57) ABSTRACT

A bistable resistively-coupled system comprises a plurality of visible nodes, a plurality of hidden nodes, and a plurality of coupling elements, each electrically connected to a visible node of the plurality of visible nodes and a hidden node of the plurality of hidden nodes, wherein each of the plurality of coupling elements comprises a programmable resistor. A coupling device for first and second nodes in a network and a method of training a bistable, resistively coupled system are also described.

### CROSS-REFERENCE TO RELATED APPLICATIONS

This application claims priority to U.S. Provisional Patent Application No. 63/176,247, filed on Apr. 17, 2021, incorporated herein by reference in its entirety.

### BACKGROUND OF THE INVENTION

Nature apparently does a lot of computation all the time, solving differential equations, performing random sampling, and so on. Transistors, for example, can be turned on and off based on the laws of nature, and are the foundation for most of computers today. However, use of these laws is different from harnessing nature's computational capability at some higher level, for example, to solve an entire problem. Indeed, some very powerful algorithms are inspired by nature. It is not hard to imagine that if a computing substrate was nature-based, it could be used to solve a certain set of problems much more quickly and efficiently than through mapping that problem to a von Neumann interface. One particular branch of this effort that has seen some recent rapid advance is Ising machines.

In a nutshell, Ising machines leverage nature to seek low energy states for a system of coupled spins. Various problems (in fact, all NP-complete problems) can be expressed as an equivalent optimization problem of the Ising formula. Though existing Ising machines are largely in the form of prototypes and concepts, they are already showing promise of significantly better performance and energy efficiency for optimization problems. However, the true appeal of these systems lies in their future opportunities. First, through design iterations, their computational capacity and efficiency will continue to improve. Second, with novel hardware, the design of algorithms (especially those inspired by nature) will co-evolve with the hardware and lead to a richer combination of problem-solving modalities.

The Ising model is used to describe the Hamiltonian of a system of coupled spins. The spins have one degree of freedom and take one of two values (+1, −1). The energy of the system is a function of pair-wise coupling of the spins (Jᵢⱼ) and the interaction (hᵢ) of some external field (μ) with each spin. The resulting Hamiltonian is shown below in Equation 1:

$$H = - {\sum }_{( i < j )} {J}_{i j} {σ}_{i} {σ}_{j} - μ {\sum }_{i} {h}_{i} {σ}_{i} \qquad Equation 1$$

A physical system with such a Hamiltonian naturally tends towards low-energy states. It is as if nature tries to solve an optimization problem with Equation 1 as the objective function, which is not a trivial task. Indeed, the cardinality of the state space grows exponentially with the number of spins, and the optimization problem is NP-complete: it is easily convertible to and from a generalized max-cut problem, which is part of the original list of NP-complete problem.

Thus if a physical system of spins somehow offers programmable coupling parameters (Jᵢⱼ and phi in Equation 1), they can be used as a special purpose computer to solve optimization problems that can expressed in Ising formula (Equation 1). In fact, all problems in the Karp NP-complete set have their Ising formula derived. Additionally, if a problem already has a QUBO (quadratic unconstrained binary optimization) formulation, mapping to Ising formula is as easy as substituting bits for spins: σᵢ=2bᵢ−1.

Because of the broad class of problems that can map to the Ising formula, building nature-based computing systems that solve these problems has attracted significant attention. Loosely speaking, an Ising machine's design goes through four steps:
1) Identify the physical variable to represent a spin (be it a qubit, the phase of an optical pulse, or the polarity of a capacitor's voltage);
2) Identify the mechanism of coupling and how to program the coefficients;
3) Demonstrate the problem-solving capability showing both the theory of its operation (reveal the “invisible hand” of nature) and satisfactory results of practice;
4) Demonstrate superior machine metrics (solution time, energy consumption, and construction costs).

It is important to note that different approaches may offer different fundamental tradeoffs and go through varying gestation speeds. Thus, it could be premature to evaluate a general approach based on observed instances of prototypes.

Some of the earliest and perhaps the best-known Ising machines are the quantum annealers marketed by D-Wave. Quantum annealing (QA) is different from adiabatic quantum computing (AQC) in that it relaxes the adiabaticity requirement. QA technically includes AQC as a subset, but current D-Wave systems are not adiabatic and thus do not have the theoretical guarantee of reaching ground state. Without the ground-state guarantee, the Ising physics of qubits has no other known advantages over alternatives. It can be argued that using quantum devices to represent spin is perhaps suboptimal. First, the devices are much more sensitive to noise, necessitating a cryogenic operating condition that consumes much power (25 KW for D-Wave 2000q). Second, it is perhaps more difficult to couple a large number of qubits than other spins, which explains why current machines use a local coupling network. The result is that for general graph topologies, the number of nodes needed on these locally-coupled machines grows quadratically and the nominal 2000 nodes on the D-Wave 2000q is equivalent to only about 64 effective nodes.

Coherent Ising Machines (CIM) can be thought of as a second-generation design where some of the issues are addressed. In T. Inagaki et al. (Science, vol. 354, no. 6312, pp. 603-606, 2016), all 2000 nodes can be coupled with each other, making it apparently the most powerful Ising machine today. CIM uses special optical pulses serving as spins and therefore can operate under room temperature and consumes only about 200 W power. However, the pulses need to be contained in a 1 km-long optical fiber and it is challenging to maintain a stable operating condition for many spins as the system requires stringent temperature stability.

Because the operating principle of CIM can be viewed with a Kuramoto model, using other oscillators can in theory achieve a similar goal. This led to a number of electronic oscillator-based Ising Machines (OIM) which can be considered as a third-generation. These systems use LC tanks for spins and (programmable) resistors as coupling units. These electronic oscillator-based Ising machines are a major improvement over earlier designs in terms of machine metrics. To be sure, their exact power consumption and operation speed depends on the exact inductance and capacitance chosen and can thus span a range of orders of magnitude. But it is not difficult to target a desktop size implementation with around 1-10 W of power consumption—a significant improvement over cabinet-size machines with a power consumption of 200 W-25 kW. However, for on-chip integration, inductors are often a source of practical challenges. They are area intensive, have undesirable parasitics with reduced quality factor and increased phase noise all of which pose practical challenges in maintaining frequency uniformity and phase synchronicity between thousands of on-chip oscillators.

Another electronic design with a different architecture is the Bistable Resistively-coupled Ising Machine (BRIM). In BRIM, the spin is implemented as capacitor voltage controlled by a feedback circuit, making it bistable. The design is CMOS-compatible and because it uses voltage (as opposed to phase) to represent spin, it enables a straightforward interface to additional architectural support for computational tasks. The systems disclosed herein therefore use a baseline substrate similar to BRIM. Note that the same principles discussed herein could directly apply to all Ising machines with different amounts of glue logic. More information about BRIM systems may be found in International Application No. PCT/US2021/070402, filed Apr. 16, 2021, incorporated herein by reference in its entirety.

The concept of energy is used not only in traditional optimization algorithms, but also in a number of machine learning algorithms collectively referred to as Energy-Based Models (EBM). The system usually consists of two sets of variables X and Y (as a concrete example, let X represent pixels of an image, and Y Boolean variables classifying the image). If the energy of the state, E(X, Y), is low, then the classification is good. In many models, the energy is similar to the Ising formula. In the well-known model of Boltzmann machine for example, if the distinction between the two set of variables is ignored and each variable is referred to as or, the energy is equivalent to the Ising model:

$$E = - {\sum }_{( i < j )} {W}_{i j} {σ}_{i} {σ}_{j} - {\sum }_{i} {θ}_{i} {σ}_{i} \qquad Equation 2$$

When using Boltzmann machines for inference, the system is also similar to using an Ising machine, but with an important difference. In both cases, the weights (Wᵢⱼ) are inputs to the system, and the output is a state (σᵢ) with low energy. The difference stems from the meaning of the variables/spins. In a Boltzmann machine, the spins include two sets of variables called the visible and hidden units. During inference, the visible units would be “clamped” to an input (e.g., an image), and only the hidden units would be allowed to change in search of a low-energy state.

Unlike in an optimization problem where the weights are part of the problem formulation, in an EBM, training is needed to obtain an optimal set of weights. Like in many machine learning algorithms, this is done by using a gradient descent approach to lower the loss function while iterating over a set of training samples. A key point to emphasize here is that the primary challenge in such a gradient descent algorithm often involves terms that are computationally intractable, necessitating approximation algorithms. Here again, a nature-computing substrate allows for approaches convenient or efficient for the substrate without the need to follow exactly the prevailing von Neumann algorithms.

In this disclosure, a physical Ising machine is shown which can help accelerate an EBM both in training and in inference in a number of different ways. For this purpose, a special case of Boltzmann machines was selected called the Restricted Boltzmann Machine (RBM) as it is a widely-used algorithm that is heavily optimized for von Neumann architectures. RBMs (and its multi-layer variants) have found applications in specialized learning and unsupervised learning. An exemplary RBM is shown in FIG. 1.

An RBM has only connections between a visible node 101 and a hidden node 102 and no connections between two visible nodes or two hidden nodes as shown in FIG. 1. As a result, the energy function is shown in Equation 3:

$$E ( v , h ) = - {\sum }_{i}^{m} {\sum }_{j}^{n} {v}_{i} {W}_{i j} {h}_{j} - {\sum }_{i}^{m} {b}_{{v}_{i}} {v}_{i} - {\sum }_{j}^{n} {b}_{{h}_{j}} {h}_{j} \qquad Equation 3$$

where Wᵢⱼ is the coupling weight between visible unit vᵢ and hidden unit hⱼ; and bᵥ_{ᵢ} and bₕ_{ⱼ} are the biases for the corresponding visible and hidden units.

Similar to other neural networks, RBMs can be stacked into a multi-layer configuration to form a deep network. Specifically, two common variants are Deep Belief Networks (DBN) and Deep Boltzmann Machines (DBM). There are subtle differences between these variants and the simpler RBM. For the sake of clarity, this disclosure will focus on RBM and follow conventional approaches when stacking multiple layers together.

### SUMMARY OF THE INVENTION

In one aspect, a bistable resistively-coupled system comprises a plurality of visible nodes, a plurality of hidden nodes, and a plurality of coupling elements, each electrically connected to a visible node of the plurality of visible nodes and a hidden node of the plurality of hidden nodes, wherein each of the plurality of coupling elements comprises a programmable resistor. In one embodiment, each of the plurality of coupling elements comprises two programmable resistors. In one embodiment, each programmable resistor comprises a field effect transistor having a source, a gate, and a drain, with a gate capacitor connected between the source and the gate. In one embodiment, each of the plurality of coupling elements comprises an analog counter having an overflow and an underflow signal, the overflow signal configured to increase a value of the programmable resistor and the underflow signal configured to decrease the value of the programmable resistor.

In one embodiment, at least one node of the plurality of visible nodes or the plurality of hidden nodes comprises a sigmoid element, the sigmoid element comprising an inverter having an input, an output, and a loading resistor connected between the output and a common mode reference. In one embodiment, at least one node of the plurality of visible nodes or the plurality of hidden nodes comprises a random noise generator, the random noise generator comprising a binary random number generator having an output, and a low-pass filter connected to the output.

In one embodiment, the system further comprises a comparator having first and second inputs, the first input connected to an output of a sigmoid element and the second input connected to the filtered output of the binary random number generator. In one embodiment, at least one node of the plurality of visible nodes or the plurality of hidden nodes comprises a capacitor and a feedback unit connected across the capacitor configured to make a voltage across the capacitor bistable. In one embodiment, at least one node of the plurality of visible nodes or the plurality of hidden nodes comprises a buffer.

In one aspect, a coupling device for connecting first and second nodes in network comprises inverted and non-inverted inputs, first and second field effect transistors, each having a drain, a gate, and a source, the drain of the first field effect transistor connected to the non-inverted input and the drain of the second field effect transistor connected to the inverting input, first and second gate capacitors connected between the gate and source of the first and second field effect transistors, respectively, a summing output connected to the sources of the first and second field effect transistors, and a voltage adjusting element connected to the gates of the first and second field effect transistors, configured to adjust the gate voltages of the first and second field effect transistors in response to a control signal.

In one embodiment, the voltage adjusting element comprises an analog counter. In one embodiment, the device further comprises at least one current source switchably connected to a gate of the first or second field effect transistor. In one embodiment, the device further comprises four current sources, with one switchably connected to each of the gates of the first and second field effect transistors and connected to a positive voltage or a ground. In one embodiment, the voltage adjusting element further comprises overflow and underflow outputs of the analog counter configured to increase or decrease the amount of charge on the first and second gate capacitors. In one embodiment, the first and second field effect transistors are N-channel field effect transistors.

In one aspect, a method of training a bistable, resistively coupled system comprises initializing a set of weighting elements and a set of biasing elements in the bistable, resistively coupled system, initializing a set of visible nodes of the bistable resistively coupled system to a first set of initial values, clamping the set of visible nodes to the first set of initial values for a period of time, and allowing a set of hidden nodes to settle at a first set of hidden values, incrementing a counter of at least one weighting element based on the product of the first set of initial values and the first set of hidden values, initializing a set of hidden nodes of the bistable resistively coupled system to a random set of values selected from a table of hidden values, annealing visible and hidden nodes for a second period of time, decrementing the counter of at least one weighting element based on the annealed values of the visible and hidden nodes, incrementing or decrementing a weighting value of the at least one weighting element if the counter of the at least one weighting element overflows or underflows, and repeating the steps from the step of initializing the set of visible nodes for a programmable number of learning steps.

In one embodiment, the set of values used to initialize the set of hidden nodes is obtained from the corresponding set of hidden values from a previous annealing step. In one embodiment, the method further comprises the step of reading coupling values from the system using at least one analog to digital converter. In one embodiment, the period of time is in a range of 1 nanosecond or less. In one embodiment, the second period of time is in a range of 1 nanosecond or less. In one embodiment, the method further comprises the step of storing the annealed values of the hidden nodes in the table of hidden values after annealing.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1 is a Restricted Boltzmann Machine;

FIG. 2 is an exemplary high-level BRIM implementation showing bistable capacitive nodes with programmable resistive coupling and programming logic;

FIG. 3 is a diagram of a high-level RBM implementation showing visible and hidden nodes, with clamping units to drive node biases, coupling mesh, and programming logic;

FIG. 4 is a pseudo-code contrastive divergence algorithm for RBM training;

FIG. 5 is a graph of distribution of BRIM energy state;

FIG. 6 is an architecture diagram of a complex design where the machine follows the gradient;

FIG. 7 is a high-level block diagram of a node;

FIG. 8 is a detail view of certain circuit elements of an exemplary node;

FIG. 9 is an exemplary coupling unit;

FIG. 10 is a graph of speedup of a Boltzmann sampler over TPU and Gibbs sampler for training different RBMs for image batch size of 500;

FIG. 11 is a graph of energy consumption of a TPU and a Gibbs sampler over various benchmarks normalized over a Boltzmann sampler for an image batch size of 500;

FIG. 12, FIG. 13A, FIG. 13B, FIG. 13C, and FIG. 13D are a graphs of average log probability of conventional algorithms (CD-1 and CD-10) and the disclosed modified algorithm used for Boltzmann gradient follower (BGF);

FIG. 14A, FIG. 14B, FIG. 14C, and FIG. 14D are graphs of the moving average of mean log probability of different models under varying amount of injected noise and variations. The data are smoothed using a moving average of 10 points;

FIG. 15A is a graph of mean absolute error (MAE) of different models under a varying amount of injected noise and variations. The final MAE ranges are between 0.771 and 0.765;

FIG. 15B is a graph of Roc curves of different models under varying amount of injected noise and variations. Final AUC ranges are between 0.964 and 0.967; and

FIG. 16 shows the cumulative probability distribution of KL divergence of CD and BGF training results against ground truth.

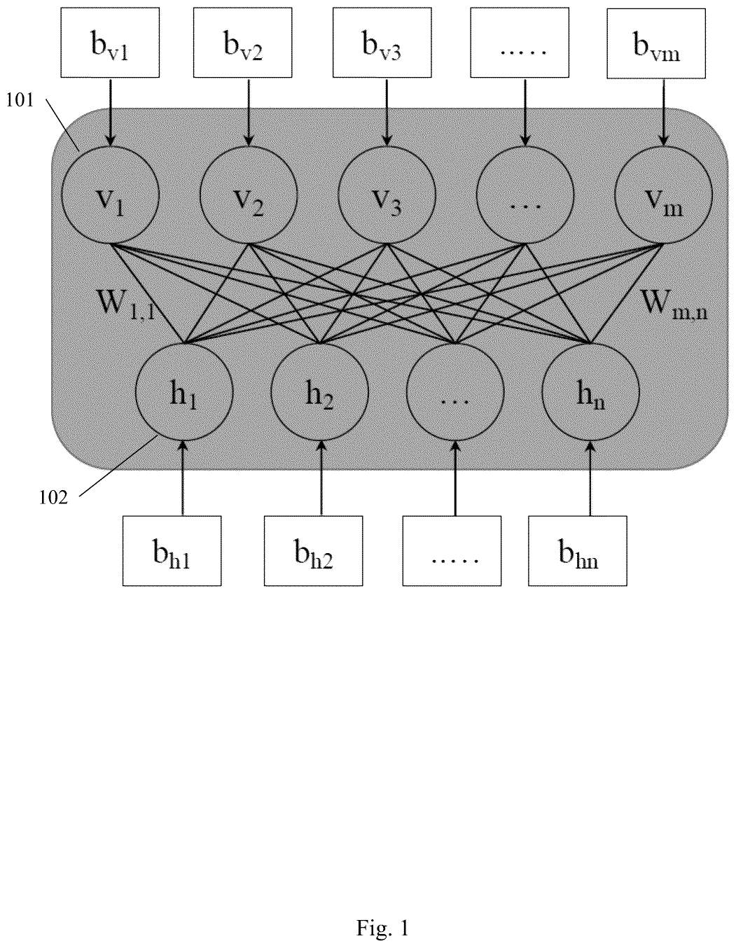

### DETAILED DESCRIPTION

It is to be understood that the figures and descriptions of the present invention have been simplified to illustrate elements that are relevant for a clear understanding of the present invention, while eliminating, for the purpose of clarity, many other elements found in related systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, exemplary methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

In one aspect, disclosed herein is an Ising machine substrate that will be the foundation for additional architecture support. The present disclosure provides a new class of augmented Ising machine suitable for both training and inference in machine learning applications.

Some Ising machines are already showing better performance and energy efficiency for optimization problems. Through design iterations and co-evolution between hardware and algorithm, more benefits are expected from nature-based computing systems. One embodiment of the disclosed device is an augmented Ising machine suitable for both training and inference using an energy-based machine learning algorithm. In one embodiment, the Ising substrate accelerates key parts of the algorithm and achieves non-trivial speedup and efficiency gain. In some embodiments, with a more substantial change, the machine becomes a self-sufficient gradient follower to virtually complete training inside the hardware. This can bring about 29× speedup and about 1000× reduction in energy consumption compared to a TPU host.

In one embodiment of the disclosure, the training step of an energy-based machine learning system is implemented in an integrated circuit by using a programmable resistive element in each of the coupling units connecting the nodes of the machine, where the resistance value of the resistive element is stored, controlled, and updated during the training process by utilizing an electronic circuit whose substantial portion is placed within the boundary of a chip area dedicated to a single coupling unit. Doing so saves energy, reduces overall chip area, and increases training speed. In another embodiment of the present invention, a random number generator whose single bit output is low-pass filtered with a continuous-time analog filter is used to produce random analog values spanning a predetermined range to achieve a random sampling of probability distributions of nodal voltages. In another embodiment of the present invention, a physical Ising machine's trajectory is utilized to produce nature random samples following a (quasi-)Boltzmann distribution. This allows an entire Markov Chain Monte Carlo algorithm to be efficiently embedded in the control circuit of a coupling unit.

### Ising Machine Substrate

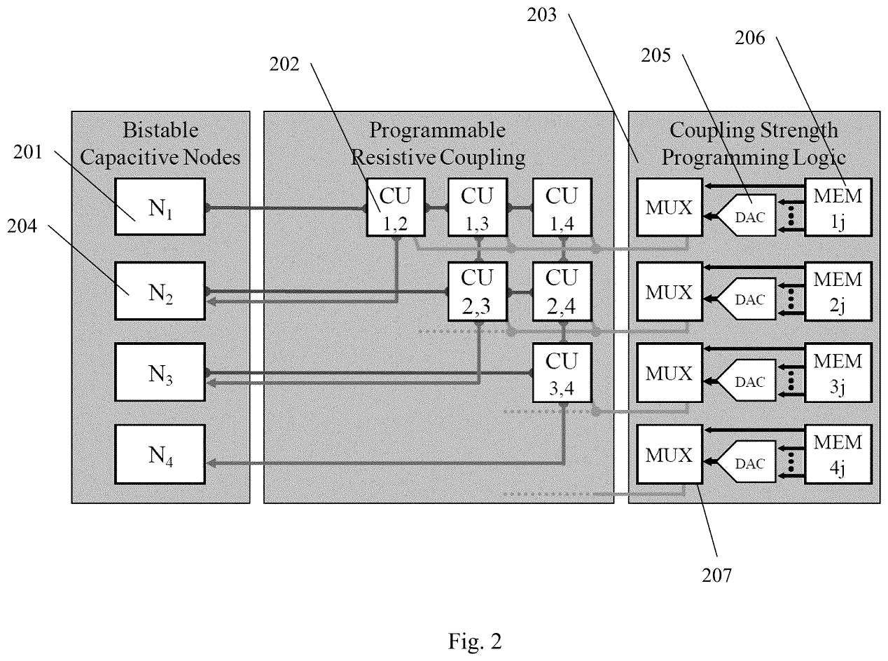

As disclosed herein, a number of physical substrates can leverage nature to perform optimization of an Ising formula. In principle, any such substrate can be used for the purpose of accelerating a machine learning algorithm. Disclosed herein is one such system using an integrated electronic design, referred to herein as BRIM. FIG. 2 shows a high-level diagram of a BRIM architecture.

The depicted architecture in FIG. 2 shows bistable capacitive nodes, e.g. 201, 204 with programmable resistive coupling 202, and the accompanying programming logic 203. Between every pair of nodes (for example nodes 201 and 204), one bi-directional coupling unit is shown 202, resulting in an upper triangular coupling network. In some implementations, the coupling unit may consist of two unidirectional parts, forming a symmetric network. In some embodiments, the programming logic may comprise one or more memory elements 206 configured to store, for example, values to be provided to the coupling elements. In some embodiments, multiple coupling units, for example an entire row of coupling units, may be connected to the same programming configuration circuit via a multiplexer 207 configured to select one or more of the coupling units to program in a given cycle. In some embodiments, a programming logic 203 may comprise one or more digital-to-analog converters, for example for reading analog values stored as a string of bits in memory 206 for use in configuration of coupling units 202.

In the depicted machine, each node 201, 204 comprises a capacitor and a feedback unit to make the capacitor bistable (1 or −1). In some embodiments, a nodal capacitor in a visible or hidden node may have a capacitance in a range of 10-100 femtoFarads (fF), or 1-10 fF, or 1-50 fF, or about 50 fF. A mesh of all-to-all programmable resistors (e.g. 202) serve to express the Ising formula the system is trying to optimize. When treated as a dynamic system, a Lyapunov analysis can be applied to the differential equations governing the nodal voltages. It can be shown that local minima of the Ising energy landscape are all stable states of the system. Put more simply, starting from a given initial condition, this system of coupled nodes will seek a local minimum without explicit guidance from a controller. In some embodiments, extra annealing control is used to inject random “spin flips” to escape a local minimum. This is analogous to accepting a state of worse energy with non-zero probability in simulated annealing.

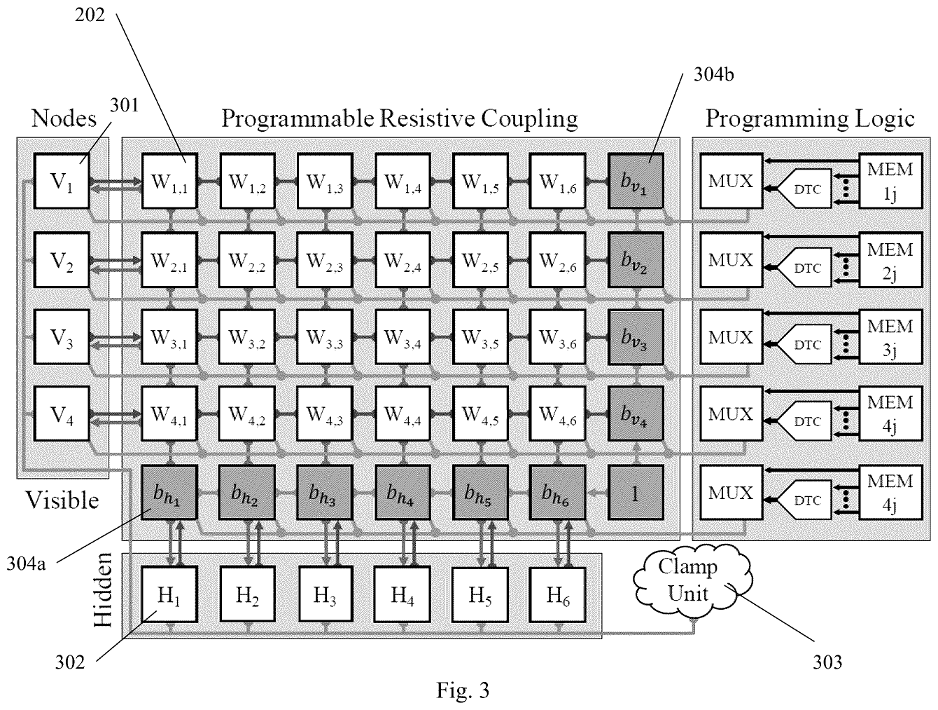

In an RBM, the nodes are separated into a bipartite graph. For such a special graph, the architecture for the Ising machine substrate can be slightly modified to have nodes on two edges of the coupling network. With reference to FIG. 3, in this structure, a visible node (e.g. 301) can only be coupled to a hidden node (e.g. 302). This layout significantly improves space efficiency compared to one that allows connection between all nodes. As a concrete example, one disclosed benchmark uses 784 visible nodes (28×28 pixels) and 500 hidden nodes. Mapping them on a generic all-to-all Ising substrate would need four times more coupling units ((784+500)² vs 784× 500).

Finally, the nodes of Ising machines can be augmented to support the operation of the RBM algorithm. In both training and inference, it is common to clamp the visible nodes or the hidden nodes to certain values. In some embodiments, a device may further comprise a clamp unit 303, configured to hold the values of the hidden nodes (e.g. 302) and/or the visible nodes (e.g. 301) during certain phases of processes as detailed herein. In one embodiment, the clamp unit 303 can be implemented with one or more digital-to-analog converters (DACs) whose analog voltage output(s) are connected to the nodal capacitor of the node(s) to be clamped. In one embodiment, the clamp unit comprises a set of 1-bit DACs that clamp capacitor voltages to either ground or power supply voltage. One important detail is that the inputs to the visible nodes are in some embodiments multi-bit values. In such implementations, multi-bit digital-to-analog and/or analog-to-digital converters may be required. In a baseline Ising machine, the vast majority of the area is devoted to the coupling units as the number of coupling units necessary scales with N² (N being the number of nodes). Thus most additions to the structure of individual nodes have a small impact on the system's complexity and chip area.

In some embodiments, a system may comprise one or more additional coupling units holding a bias value, for example coupling units 304a and 304b in FIG. 3. For example in Equation 4 below, the term bₕ_{ⱼ} is the bias value for the j^{th} hidden node, which is implemented in the depicted embodiment as an additional coupling unit. In one embodiment, the additional coupling unit includes a programmable resistor with a resistance proportional to 1/bₕ_{ⱼ} connected between, for example, a power rail voltage (e.g. 1V, 3.3V, 5V) and the input of the summing unit of the j^{th} hidden node. The resulting current is added to the incoming current from the visible nodes vᵢ to determine the final state of the j^{th} hidden node.

### Gibbs Sampler Architecture

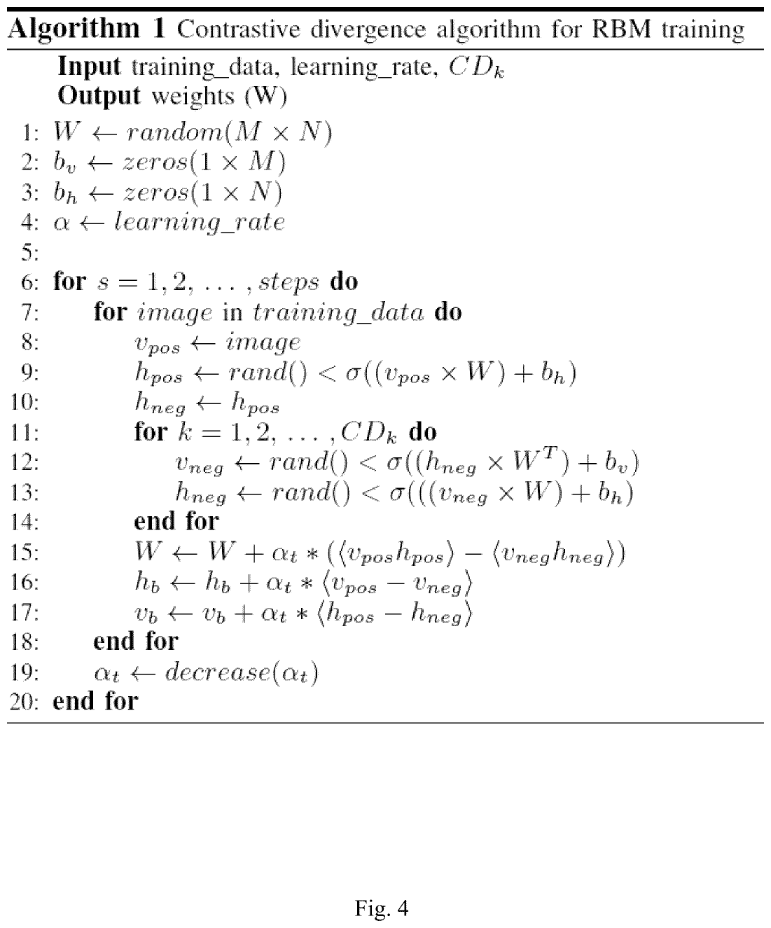

One variant of an RBM accelerator is more traditional: simply leveraging an Ising substrate to accelerate a portion of a software algorithm that naturally suits the hardware. For convenience, the accelerator design in question is referred to herein as a Gibbs sampler, as it follows the traditional Gibbs sampling-based algorithm, shown in FIG. 4.

As shown in the algorithm of FIG. 4, The training loop (lines 7 to 18) includes repeated calculations of vₚₒₛ, hₚₒₛ and v_{neg}, h_{neg}. In a nutshell, the algorithm is a stochastic gradient descent and the training loop is calculating the stochastic gradient for every weight Wᵢⱼ. In the so-called positive phase (lines 8, 9), a training sample vₚₒₛ is clamped to the visible nodes; and a corresponding sample for the hidden nodes hₚₒₛ is generated based on the conditional probability formula

$$P ( {h}_{j} = 1 \vert v ) = σ ( {b}_{{h}_{j}} + {\sum }_{i} {W}_{i j} {v}_{i} ) \qquad Equation 4$$

where σ(x) is the logistic function

$$\frac{1}{( 1 - {e}^{- x} )} \qquad Equation 4.1$$

In the negative phase (lines 12, 13 of FIG. 4), a k-step Gibbs sampling is performed. Keeping the current hidden node values, a set of new visible nodes is probablistically generated, with probabilities as shown in Equation 5:

$$P ( {v}_{i} = 1 \vert h ) = σ ( {b}_{{v}_{i}} + {\sum }_{j} {W}_{i j} {h}_{j} ) \qquad Equation 5$$

From there, the updated visible nodes project back to generate updated hidden nodes, forming one complete step of the Markov Chain Monte Carlo (MCMC) algorithm. In principle, one such step in the MCMC algorithm would make a rather poor sampling. In practice, a small number of k steps are chosen to balance the cost and the quality of the sampling. Such a k-step contrastive divergence algorithm is often referred to as CD-k.

At every learning step, the current weight matrix [Wᵢⱼ]_{M×N} vis programmed to the coupling array such that the resistance at each unit Rᵢⱼ is proportional to

$$\frac{1}{{W}_{i j}} \qquad Expression 5.1$$

This step is analogous to programming the optimization formula in a standalone Ising machine. If one set of nodes (e.g., visible) is further clamped to fixed values, each coupling unit produces a current equal to the voltage of the visible node divided by the resistance of the programmable coupling unit, which is equivalent to multiplying the corresponding weight in the matrix. Each hidden node, therefore, sees the sum of the current in the entire column. Used this way, the coupling array is effectively producing a vector-matrix multiplication operation.

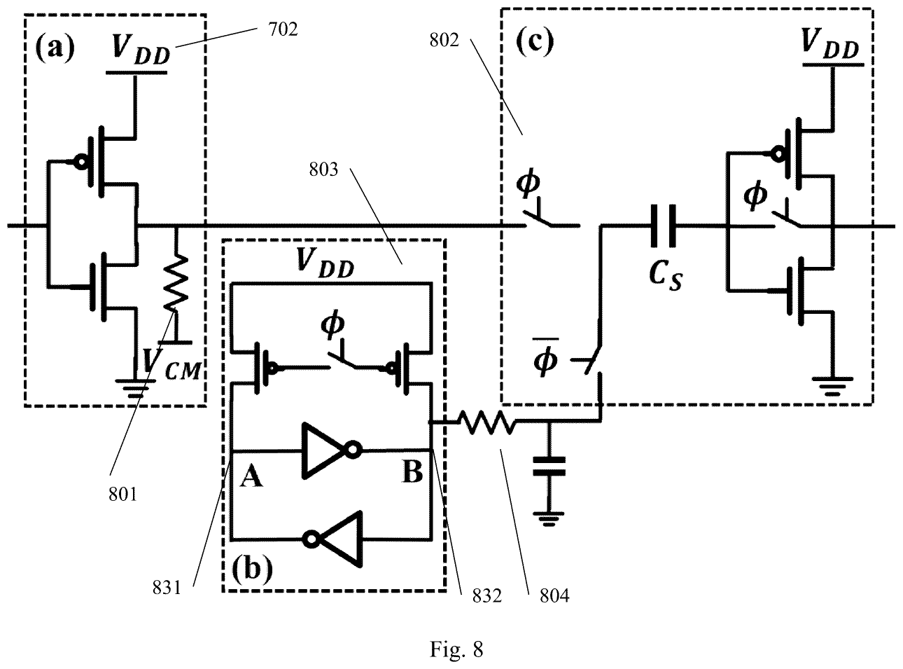

At this stage, rather than reading out the resulting currents, the current is fed through a non-linear circuit that produces the effect of a logistic function. In fact, when properly configured, a simple inverter can approximate the function admirably. Finally, the output of the logistic function is the probability of the node being 1. This can also be supported with a relatively straightforward circuit: a comparator with the other input being fed with pseudo random voltage level. The high-level building block diagram is shown in FIG. 8, with the accompanying description below explaining the circuit implementation details.

With the architectural support described, in some embodiments, much of the training loop of the algorithm of FIG. 4 is offloaded to the hardware. The remaining operations may in some embodiments be carried out on digital functional units such as a TPU, but in other embodiments hardware implementations as disclosed herein may perform all the functions of the algorithm of FIG. 4. One exemplary operation sequence is as follows:
1) Initialization on TPU;
2) Programming the random coupling matrix and biases to the Ising substrate;
3) Clamping the visible units to a training sample (vₚₒₛ);
4) Read out the hidden units (hₚₒₛ) after the Ising substrate finishes operation;
5) Perform k steps of Gibbs sampling by alternately clamping the hidden units and the visible units to produce samples on the other side.
6) Read out the final value from the visible (v_{neg}) and hidden units (h_{neg}).
7) Compute (on TPU) the new coupling matrix and biases.
8) Repeat from step 2 for subsequent learning steps.

### Boltzmann Gradient Follower Architecture

The system described above represents an improvement over digital units. However, this is largely due to the efficiency gain from approximate analog implementations. The benefit of nature-based computing is often much greater when an entire algorithm can leverage some natural processes. For this to happen, a deeper understanding of the intention of the algorithm is needed.

With RBM, the goal is to capture the training data with a probability distribution model. The probability is exponentially related to the energy of a state as in a Boltzmann distribution (hence the name):

$$P ( v , h ) ∝ {e}^{- E ( v , h )} \qquad Equation 6$$

Clearly the probabilities need to sum up to one, thus the equation for the probability of a particular state (v, h) is:

$$P ( v , h ) = \frac{1}{Z} {e}^{- E ( v , h )} ; Z = {\sum }_{v , h} {e}^{- E ( v , h )} \qquad Equation 7$$

“Capturing” the training data means the machine's model (weights and biases) maximizes the probability of all T training samples. In other words, it maximizes Πₜ₋₁^{m}P(v^{(t)}) where v^{(t)} is the t^{th} training sample, or equivalently the sum of the log probability: Πₜ₋₁^{m} log (P(v^{(t)})) Note that P(v)=ΣₕP(v, h). Because the probability is a function of the parameters (coupling weights and biases), the gradient of each parameter is followed. For the coupling parameter, the gradient is as follows:

$$\frac{\partial {\sum }_{t = 1}^{T} log P ( {v}^{( t )}}{\partial {W}_{ij}} = {\sum }_{t = 1}^{T} \frac{\partial [ log ( {\sum }_{h} {e}^{- E ( {v}^{( t )} , h )} ) - log ( Z ) ]}{\partial {W}_{ij}} \qquad Equation 8$$

For notional clarity, only the contribution of one training sample (u=v^{(t)}) to the gradient is used, and the focus is on the first part in the numerator:

$$\begin{matrix}\frac{\partial log ( {\sum }_{h} {e}^{- E ( u , h )} )}{\partial {W}_{ij}} = \frac{1}{{\sum }_{h} {e}^{- E ( u , h )}} \frac{\partial {\sum }_{h} {e}^{- E ( u , h )}}{\partial {W}_{ij}} \\ = \frac{1}{{\sum }_{h} {e}^{- E ( u , h )}} {\sum }_{h} {e}^{- E ( u , h )} \frac{\partial ( - E ( u , h ) )}{\partial {W}_{ij}} \\ = \frac{{\sum }_{h} {e}^{- E ( u , h )} {u}_{i} {h}_{j}}{{\sum }_{h} {e}^{- E ( u , h )}} = {〈 {u}_{i} {h}_{j} 〉}_{data}\end{matrix} \qquad Equation 9$$

Here the notation <⋅> data means the expectation with respect to the data, i.e., keeping the data constant (u) and averaging over all possible h.

Following the same steps, the second part of the gradient

$$( \frac{\partial log Z}{\partial {W}_{i j}} )$$

is:

$$\frac{\partial log ( Z )}{\partial {W}_{ij}} = \frac{{\sum }_{v , h} {e}^{- E ( v , h )} {v}_{i} {h}_{j}}{{\sum }_{v , h} {e}^{- E ( v , h )}} = {〈 {v}_{i} {h}_{j} 〉}_{model} \qquad Equation 10$$

Here the notation [symbol] ⋅ [symbol] model means the expectation with respect to the entire state space given by the current model (coupling parameters and biases).

As shown, to calculate any parameter's gradient, it is necessary to calculate the expectation of a large number of states, which is impractical. The common solution is an MCMC algorithm (e.g., CD-k), just like simulated annealing in solving an Ising formulation problem. Indeed, in both cases, the Markov chains are time-inhomogeneous.

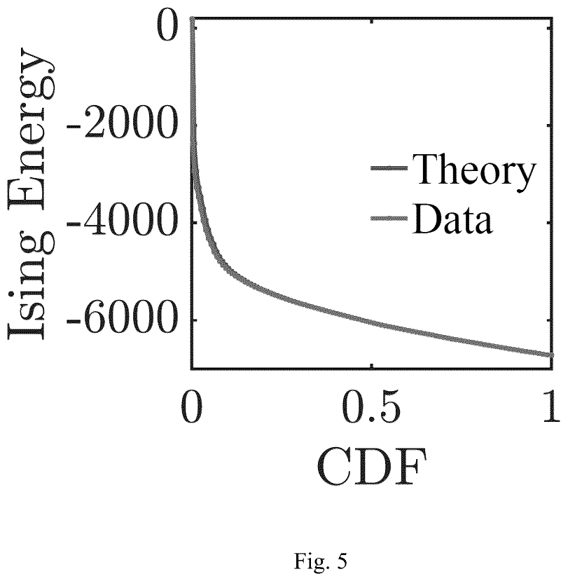

The Ising machine substrate that can be used to be considered as a special Markov chain and essentially performs a type of sampling of the state space. FIG. 5 shows the cumulative distribution of the energy of states visited by the disclosed Ising substrate and a fitted curve of a Boltzmann distribution for the same set of energies. The agreement suggests that this Ising substrate can be considered as a Boltzmann sampler. With such a sampler, samples of the negative phase (lines 11 to 14 in the algorithm in FIG. 4) can be produced to calculate the model expectation (v_{neg}h_{neg}).

When the Ising substrate is initialized to some initial condition, it will proceed to traverse through the energy landscape directed by both the system's governing differential equations and the annealing control. This has the effect of “sampling” the state space and arguably produces samples much better than the algorithmic random walk in CD-k. However, the production of the samples is much faster than the host computer can typically access and postprocess them to obtain the expectations. Disclosed herein, therefore, is a more direct approach, where the sampled expectations (<vᵢhⱼ>_{data} or <vᵢhⱼ>_{model}) are directly added to or subtracted from the model parameter (e.g., Wᵢⱼ) inside the Ising substrate, without involving the host.

In the CD-k algorithm, the accumulation is expressed as follows, where <⋅>ₛ indicates the expectation over a set of samples s:

$${W}_{ij}^{t + 1} = {W}_{ij}^{t} + {α}_{t} ( {〈 {v}_{pos} {h}_{pos} 〉}_{s} - {〈 {v}_{neg} {h}_{neg} 〉}_{s} ) \qquad Equation 11$$

Here the expectations are accumulated over a minibatch of (e.g., n=100) samples before being used to update the parameter to the next value. The choice of n is usually a matter of convenience and some trial and error. For implementation convenience, the samples are accumulated with a different minibatch arrangement: a pure digital counter would be significantly larger than the disclosed coupling unit and more power-hungry. Fortunately, such a counter can be made using analog circuitry that takes much less area and energy in exchange for noise-induced errors. In some embodiments, an analog up-down counter is used. Any increment or decrement takes effect on the counter, and only when the counter overflows or underflows is Wᵢⱼ actually adjusted by charging or discharging the appropriate capacitors.

To summarize, the net result of one embodiment of the disclosed design is that instead of using a fixed minibatch size, the disclosed machine effectively uses a variable minibatch size. The minibatch is data-dependent and thus different for each parameter. Additionally, the circuit implementation of the counter adds an effective noise on top of the noise due to stochastic sampling of the gradient. All non-idealities are faithfully modeled when the system is evaluated. A fine point can be made here as to whether the disclosed learning algorithm produces a biased estimator or not. Empirical analysis shows estimation bias appears to have no effect on the ultimate accuracy measures. Indeed, in some embodiments, the disclosed modifications appear to reduce bias from the commonly used algorithms. This is discussed in further detail in Experimental Example #2 below.

For negative phase samples, p different initial conditions are used for the hidden units (h^{(k)}, k=1 . . . p) to allow p independent random walks. These are often referred to as p particles. After each positive phase, one of the particles (say, h⁽³⁾) is loaded, and annealing of the Ising machine is performed (equivalent to the random walk of the von Neumann algorithm). In some embodiments, the annealing time is less than 5 ns, less than 4 ns, less than 3 ns, less than 2 ns, less than 1 ns, less than 500 ps, about 1 ns, or any other suitable range. Then, a sample of v_{neg}h_{neg} is taken and the resulting hidden unit values are stored back to the location of the p particle which was loaded, in this case h⁽³⁾. In some embodiments, results may be stored in a different location, for example in the location of a different p particle or in a location distinct from the existing p particles.

The parameters are physically expressed by the conductance of configurable resistors. Resistors are implemented by transistors with variable gate-source voltages. Increasing and decreasing the parameters can be achieved by raising or lowering the gate voltages. This in turn can be achieved by briefly turning on a charging or discharging circuit connected to the effective gate capacitor. This turns out to be not as easy as thought because of multiple non-linearity issues in the circuit elements. The result is slower gradient descent when the values are close to 0. While it does not affect the overall efficacy of the disclosed machine, in some embodiments, a slightly more involved version is used (discussed in more detail below) where the issue is significantly mitigated.

Finally, because the entire learning is now conducted inside the (augmented) Ising substrate, the coupling unit is larger and more complex. Furthermore, the trained results need to be read out at the end of the learning process, requiring extra analog-to-digital converters (ADC) which are expensive in cost and surface area. Nevertheless, they are only used once at the end of the algorithm.

In short, though the architecture needs some non-trivial new circuits and small modifications to the operating algorithm, it carries out the intention of a traditional software implementation. As demonstrated herein, the resulting quality is no different from a software implementation even under non-trivial noise considerations.

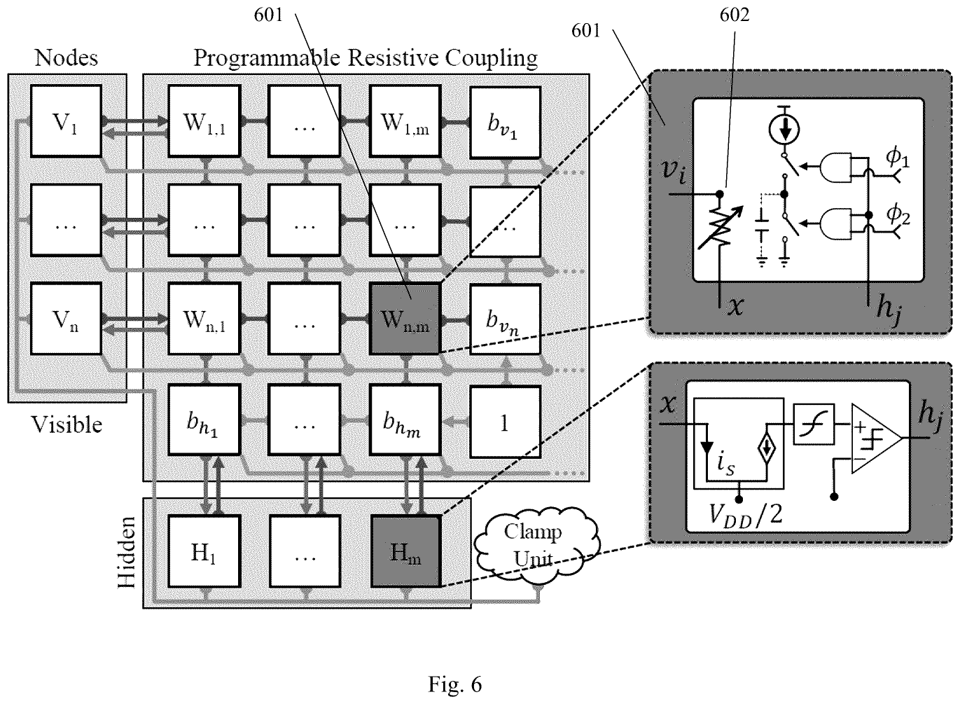

FIG. 6 shows one embodiment of a disclosed Boltzmann gradient follower architecture. The key addition is to the coupling unit (e.g. 601) where the programmable resistor 602 serving as the weight can be adjusted in place. This is achieved through controlled charging and discharging pulses that adjust the gate voltage of the transistors that serve as the programmable resistor. With this architecture, the digital (host) computer takes a much more peripheral role, mostly setting the system up, feeding data at a fixed frequency, and finally reading the results. The operation can be described as follows:
1) Initialize the weights and biases. (In some embodiments, the weights are initialized to small random values. This could certainly be implemented by the hardware itself. But programmable initial conditions may be useful for special purposes (e.g., research).
2) The host then sends training samples to latches at the visible units.
3) The machine will clamp the data, wait for a predetermined time (e.g., 1 ns or less) for the hidden units to settle.
4) The resulting sample (vₚₒₛhₚₒₛ) will be used to increment the counter for Wᵢⱼ. For example, if both vₚₒₛ and hₚₒₛ are 1, then counter Wᵢⱼ will be incremented by a constant value.
5) The machine will then load one of p particles and start the annealing process lasting e.g. for 1 ns or less, which constitutes one step of the training algorithm.
6) After annealing, the resulting sample (v_{neg}h_{neg}) will be used to decrement the analog counter for Wᵢⱼ. For example, if both v_{neg} and h_{neg} are 1, then the counter Wᵢⱼ will be decremented by a constant value. Hence the increment or decrement of the counter only happens when the product of v and h is equal to 1, otherwise the counter will not be incremented or decremented. The amount of increment or decrement depends upon the learning rate.
7) If any counter overflows or underflows, the charging or discharging circuit will be activated to increment or decrement Wᵢⱼ by a fixed amount and the (analog) counter is reset.
8) The process of steps (2-7) is repeated for a programmable number of learning steps. Then the ADCs will read out the coupling voltages one column at a time.

### Circuit

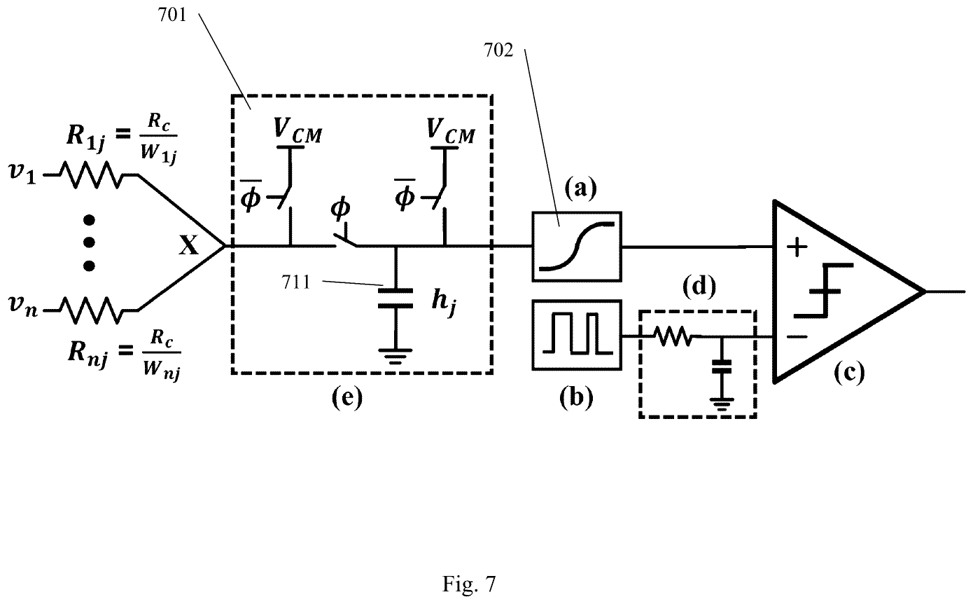

In addition to the circuits needed to implement the baseline Ising substrate, extra circuits are needed in the nodes to make them probabilistic according to RBM algorithms, which are summarized in FIG. 7. Specifically, a current summing circuit, a sigmoid function, and a random number generator. Finally, for the Boltzmann gradient follower architecture, a coupling unit is needed. All are discussed in more detail below.

The current summation circuit 701 is performed in two non-overlapping clock phases (ϕ and ϕ′). During the reset phase (ϕ′), both the hidden node capacitor 711 and the column bus connecting visible nodes to the hidden node hⱼ are pre-charged to V_{CM}=V_{dd}/2. During the subsequent integration phase (ϕ), the capacitor 711 is connected to the column bus and integrates all the currents for a fixed time interval tᵢₙₜ (e.g., 5 ns or less, 4 ns or less, 3 ns or less, 2 ns or less, 1 ns or less, 500 ps or less, etc.) producing an output voltage equal to

$$\frac{{t}_{i n t}}{{C}_{h j}} {Σ}_{i} \frac{{v}_{i}}{{R}_{i j}}$$

which is then sent to the sigmoid unit 702.

In general, a sigmoid function is monotonic, and has a first derivative which is bell shaped. The simplest circuit which exhibits similar characteristics is an inverter, as shown in detail view of sigmoid unit 702 in FIG. 8. A couple of issues need to be addressed before using an inverter as a sigmoid unit. First, the transfer function of a typical inverter used as a logic-gate consists of three distinct regions (i.e., two triode regions closer to the power rails and a steep region in the middle due to an inverter's high gain around the threshold), while a sigmoid function typically has a smoother transfer function. The inverter's transfer function may be more closely aligned with the sigmoid function by reducing its gain, which could be achieved by increasing the transistors' channel lengths and adding a loading resistor 801 at the output. In various embodiments, the loading resistor 801 may have a resistance of, for example, between 3 kΩ and 30 GΩ, or between 3 kΩ and 100 kΩ, or between 3 kΩ and 1 MΩ, or between 1 MΩ and 100 MΩ, or between 1 MΩ and 1GΩ, or between 1 GΩ and 30 GΩ, or any other suitable range.

The second issue is that the inverter's transfer function is a vertically flipped image of a general sigmoid function, which is mitigated by introducing an additional inversion in subsequent stages. In one example, this effect can be mitigated by using an inverting comparator as shown in element 802 of FIG. 8.

Thermal noise from electronic devices can be used to generate randomness. The circuit shown in element 803 of FIG. 8 is one kind of random number generator (RNG) and its operation is as follows. When ϕ is low, nodes A (831) and B (832) are pulled up to V_{dd}, which is a metastability point. When ϕ goes high, the circuit enters into an evaluation phase: both nodes discharge towards the switching point of the inverter, then the large gain at this point pulls one of the nodes A or B to V_{dd}, while the other is pulled down to ground, depending on the sign of the differential thermal noise. The RNG circuit itself produces a binary random sequence (i.e., the output is either V_{dd} or 0), which is not directly suitable to achieve probabilistic sampling at the output of the sigmoid function. However, the binary random sequence at the output of the RNG 803 is readily converted to a white-noise uniformly distributed from 0 to V_{dd}, by applying an RC low-pass filter 804 as shown in FIG. 8. The resulting white-noise is then compared against the output of the sigmoid function in a standard dynamic comparator 802 to achieve probabilistic sampling. In various embodiments, the low-pass filter 804 may have a pass band of less than 5 GHz, less than 2 GHZ, less than 1 GHz, less than 500 MHZ, less than 100 MHz, or any other suitable pass band.

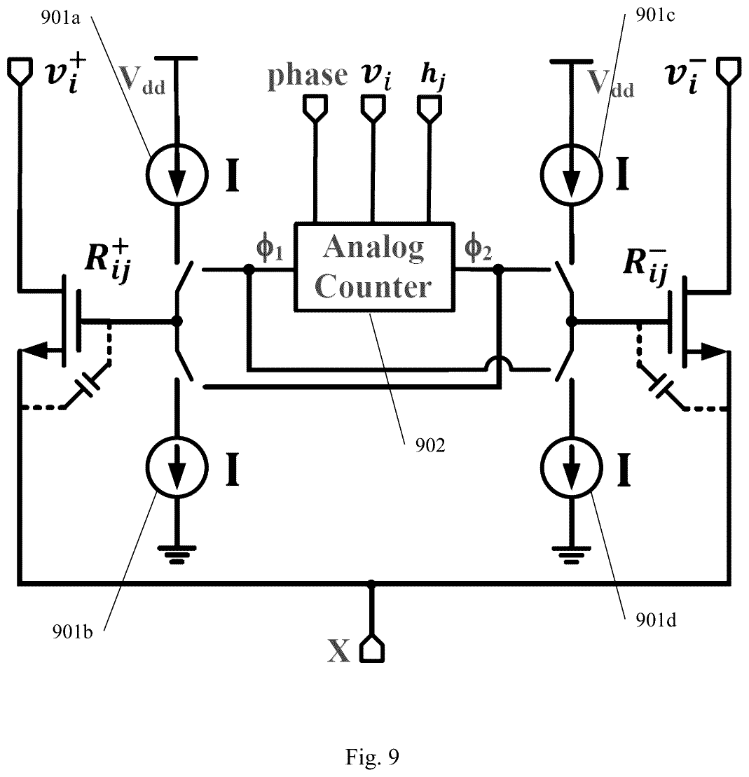

With reference to FIG. 9, an exemplary coupling unit is shown which comprises two programmable resistors (Rᵢⱼ⁺ and Rᵢⱼ⁻), four current sources (901a, 901b, 901c, and 901d), and a two-stage 8-bit analog counter 902. Two programmable resistors are used to represent both positive and negative weights of RBM. vᵢ⁺ in FIG. 9 represents the actual input, while vᵢ represents 1−vᵢ⁺. Note that Rᵢⱼ⁺ and Rᵢⱼ⁻ always update in the opposite directions, i.e., when Rᵢⱼ⁺ increases by delta, Rᵢⱼ⁻ decreases by delta.

This is achieved by turning on only one pair of diagonal current sources (e.g. 901a and 901d). During the initialization phase, the Digital to Time Converter (DTC) in the programming logic (see FIG. 3) sets the gate voltage of Ry and Ry to some random values by charging their gate capacitors, which translates to random weights. During the sampling of states, currents of vᵢ⁺/Rᵢⱼ⁺ and vᵢ⁻/Rᵢⱼ⁻ are summed up at node X then sampled, as shown in FIG. 7. In some embodiments, the analog counter 902 comprises two cascaded 4-bit stages. The counter is incremented during the positive phase and decremented during the negative phase based on the vᵢhⱼ value. ϕ₁ and ϕ₂ in the figure represent the overflow and underflow signals of the analog counter, respectively, which are used to charge (or discharge) the gate capacitance of Rᵢⱼ and Rᵢⱼ. The amount of delta to be added to the weights depends upon on the learning rate. Hence it is possible to control the amount of charge that needs to be injected onto the gate capacitance by varying the pulse width of the overflow or underflow signals. In this fashion, the weights can be updated.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the system and method of the present invention. The following working examples therefore, specifically point out the exemplary embodiments of the present invention, and are not to be construed as limiting in any way the remainder of the disclosure.

To better understand the characteristics of the disclosed augmented Ising substrate for EBMs, various metrics were compared between the disclosed design and an implementation with TPUs. It is worth noting that an evolutionary perspective is needed when viewing the results. Both digital numerical architectures and nature-based computing systems will evolve. Design refinement can bring significant changes to these metrics. More importantly, the line between the two groups will continue to blur and cross pollination is very much an intended consequence.

The below Experimental Example describes the experimental setup including benchmark RBMs and DBN models; then shows quantitative comparisons between a TPU and a noiseless model of the disclosed analog design in terms of energy efficiency and throughput; and finally presents a few in-depth analyses to help understand the how the system behaves.

### Experiment #1—Experimental Setup

To evaluate the systems discussed, the systems were trained on different applications like image classification, recommendation systems and anomaly detection. For image classifications, different datasets were used which include handwritten images (MNIST), Japanese letters (KMNIST), fashion images (FMNIST), extended handwritten alphabet images (EMNIST), color images (CIFAR10), and a toy dataset (SmallNorb). Images range from 28×28 gray scale (NIST), to 96×96 gray scale (SmallNorb), and 32×32 colored (CIFAR10). RBM and DBN algorithms were used to train all NIST datasets and a Convolution RBM algorithm was used for the CIFAR10 and SmallNorb datasets. To train the RBM as a recommendation system and anomaly detector, the 100k MovieLens dataset and “European Credit Card Fraud Detection” datasets were used, respectively. The learning rate used to train these models was 0.1 and the size of the RBM and DBN configurations are shown in Table 1. Since RBMs are unsupervised models, one way to quantify the quality of training is the average log probability of the training samples which can be measured using annealed importance sampling. Also reported are some common metrics like classification accuracy using a logistic regression layer at the end for image classification, mean absolute error (MAE) of test data and projected data for recommendation systems and area under Receiver operating characteristic (ROC) curve for Anomaly detection.

TABLE 1

| Datasets | RBM | DBN-DDN |
|---|---|---|
| MNIST | 784-200 | 784-500-500-10 |
| KMNIST | 784-500 | 784-500-1000-10 |
| FMNIST | 784-784 | 784-784-1000-10 |
| EMNIST | 784-1024 | 784-784-784-26 |
| CIFAR10 | 108-1024 | — |
| SmallNorb | 36-1024 | — |
| Recommendation systems | 943-100 | — |
| Anomaly detection | 28-10 | — |

The modeling of the disclosed design is relatively straightforward. It is assumed that the system has the enough nodes to fit the largest problems in the set. Thus execution time is just the product of the number of iterations and the cycle count per iteration. Anything not carried out on the disclosed hardware system is performed on the host machine, which is assumed to include the same TPU as the baseline.

A first-order analysis of the disclosed system is desired because there are many variables involved and to pretend every parameter is precisely estimated is disingenuous. Roughly speaking, it is believed that the results reported should be accurate within an order of magnitude. In other words, it is extremely unlikely that an actual implementation following the exact design will yield results more than about 3× better or 3× worse. Not all parameters have an equally wide range of the confidence region. Execution time, for instance, has a tight bound because it is simply a result of repeated iterations and the circuit can certainly be designed to meet the relatively conservative cycle time. Area and power (especially of elements that were not customized for the disclosed design, such as the DTC) have a reasonably large design space such that numbers used represent only the best estimates of the metrics of what would have been chosen given current off-the-shelf offerings. Sizing of the transistor has been determined to keep noise at a reasonable level. A primary concern of such a study is whether the proposed system would work at all. The biggest unknown is the collective impact of noise, for which some sensitivity analysis will be provided herein.

### Execution Speed

First, the execution speed of the two proposed architectures is compared: the Gibbs sampler and the Boltzmann gradient follower (BGF). The operating frequency of both Gibbs sampler and BGF is 1 GHz. For comparison, TPU (v1) is used as a baseline. TPU was modeled to perform fixed point 8-bit operations at a clock frequency of 700 MHz. The same frequency was assumed for the disclosed digital control.

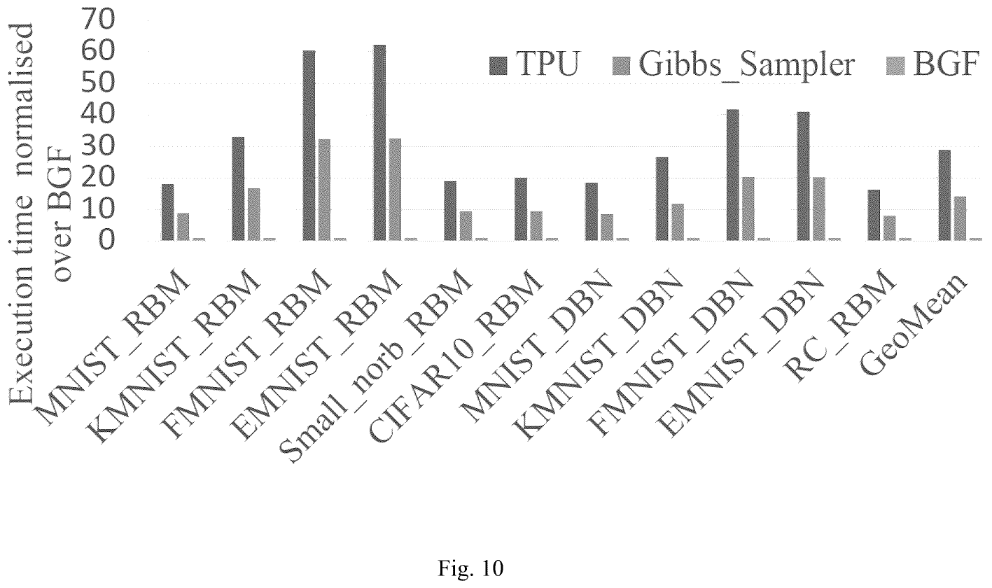

FIG. 10 shows a graph of speedup of different benchmarks. As shown, for larger networks, a bigger portion of the hardware is being utilized and the speed advantage will increase. Of course, when the problem is larger than what a single chip can map, then either multi-chip solutions are needed, or some of the computation has to be performed elsewhere, such as on the host. The datasets that were used in these examples all comfortably fit inside a small die. This example will therefore focus only on single-chip analysis.

Overall, in a first-order approximation, adding a Gibbs sampler or a Boltzmann gradient follower to a TPU array will increase area fractionally, but improve speed by a geometric mean of 2× (Gibbs) or 29× (BGF).

### Energy and Area

Energy consumption was examined next, which involved more uncertainty. A simplified first-principle analysis is used below as a starting point before discussing an estimate of whole system results.

A primary source of fundamental efficiency of an Ising substrate comes from the fact that many algorithms are mimicking nature, whereas the disclosed hardware directly embodies that nature. For example, in a typical step of MCMC, to flip one node requires roughly O(N) multiply-accumulate (MAC) operations followed by some probability sampling. Ignoring the probability sampling, each MAC operations cost on the order of a pJ. For the problems discussed, N≈1000. So one such flip requires on the order of nJ using conventional digital computation. By contrast, in BRIM, flipping a node involves a distributed network of currents charging/discharging a nodal capacitor. With nodal capacitors on the order of 50 fF and a voltage of roughly 1V, flipping a node takes on the order of 50 fJ. Thus, an Ising substrate has the potential to be about 4 orders of magnitude more efficient compared to a conventional computational substrate.

When it comes to the entire system, the energy savings will depend on several factors not included in the simplified analysis above. To obtain an estimate of power/energy, circuits were designed in Cadence 45 nm using the Generic Process Design Kit (GPDK045). This is the latest technology whose design kit was available for this analysis. The area and power consumed by the TPU unit were obtained from X. He, et al., Proceedings of the 34th ACM International Conference on Supercomputing, 2020, pp. 1-12, which uses a 28 nm technology.

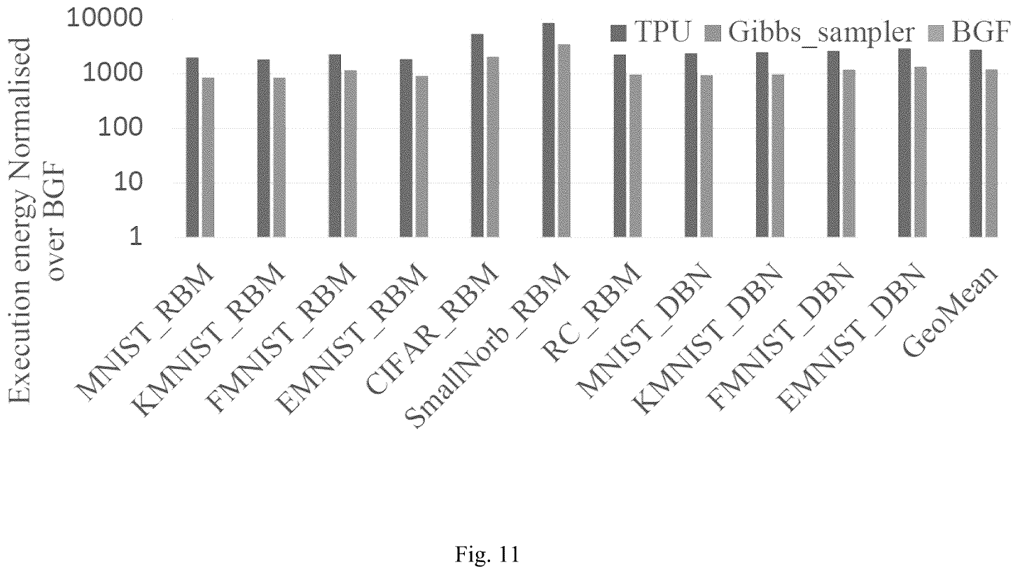

With the technology difference in mind, the energy consumption of different benchmarks can be compared as shown in FIG. 11. All energy results were normalized to that of a Boltzmann gradient follower. FIG. 11 shows the energy consumption of a TPU implementation and Gibbs sampler over various benchmarks normalized over a Boltzmann sampler for an image batch size of 500.

The disclosed accelerators were more efficient in the effective operations carried out than digital TPU operations prescribed by the algorithm. Overall, the disclosed accelerators demonstrated improvements of around 1000×.

Two qualitative points are worth mentioning. On the one hand, a digital circuit can still improve and more efficient designs can further reduce per-operation cost. On the other hand, the type of short random walks performed on the disclosed Boltzmann gradient follower architecture are not the most efficient use of the architecture. Further algorithm innovation may well find applications that fully utilize the ability of the disclosed and similar nature-based systems.

Next, chip area was estimated. Again, with the technology difference this is also not a direct comparison. Nevertheless, the baseline 28 nm TPU takes about 330 mm² with 24% of it being the MAC array. In comparison, the area and power of BGF and its building blocks are shown in Table 2. Because the coupling unit is by far the most numerous element (roughly O(N²) vs. O(N) for other units), the area is largely determined by the coupling units. Assuming a 1024×1024 array, a Gibbs sampler architecture costs a little over 1mm², essentially negligible. For a Boltzmann gradient follower, the area is about 16mm², making it about 4.8% of the total host TPU area. As shown in Table 3, BGF are much more efficient—in this specialized algorithm—than TPU or the state-of-the-art computational accelerators.

TABLE 2

| | 400 × 400 | | 800 × 800 | | 1600 × 1600 | |
|---|---|---|---|---|---|---|
| | area | power | area | power | area | power |
| Components/Nodes | (mm²) | (mW) | (mm²) | (mW) | (mm²) | (mW) |
| CU (Gibbs) (N²) | 0.24 | 56 | 0.96 | 101 | 3.84 | 192 |
| CU (BGF) (N²) | 3 | 96 | 10 | 262 | 39 | 834 |
| SU (N) | 0.002 | 0.97 | 0.004 | 1.94 | 0.008 | 4 |
| Comparator (N) | 0.03 | 2 | 0.06 | 4 | 0.12 | 8 |
| DTC (N) | 0.1 | 5 | 0.19 | 10 | 0.39 | 20 |
| RNG (N) | 0.006 | 12 | 0.012 | 24 | 0.03 | 48 |
| Total (Gibbs) | 0.38 | 78 | 1.23 | 148 | 4.38 | 295 |
| Total (BGF) | 3.1380 | 116 | 10.2660 | 301 | 39.5480 | 910 |

TABLE 3

| Accelerators | T-OPs/s × mm² | T-OPs/W |
|---|---|---|
| TPU | 4.56 | 7.37 |
| TIMELY | 38.33 | 21.00 |
| BGF | 230 | 3800 |

### Impact of Algorithmic Change

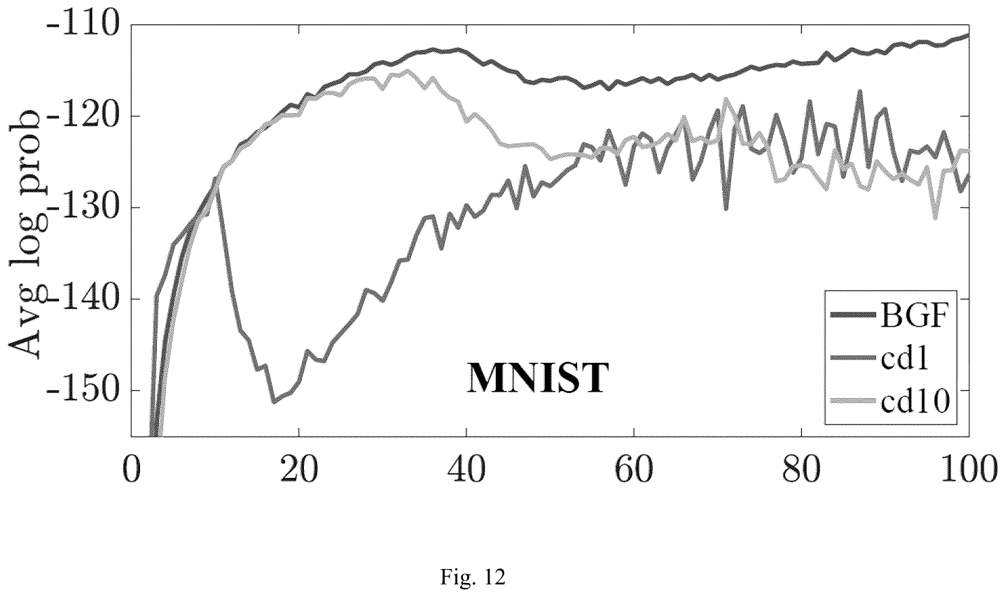

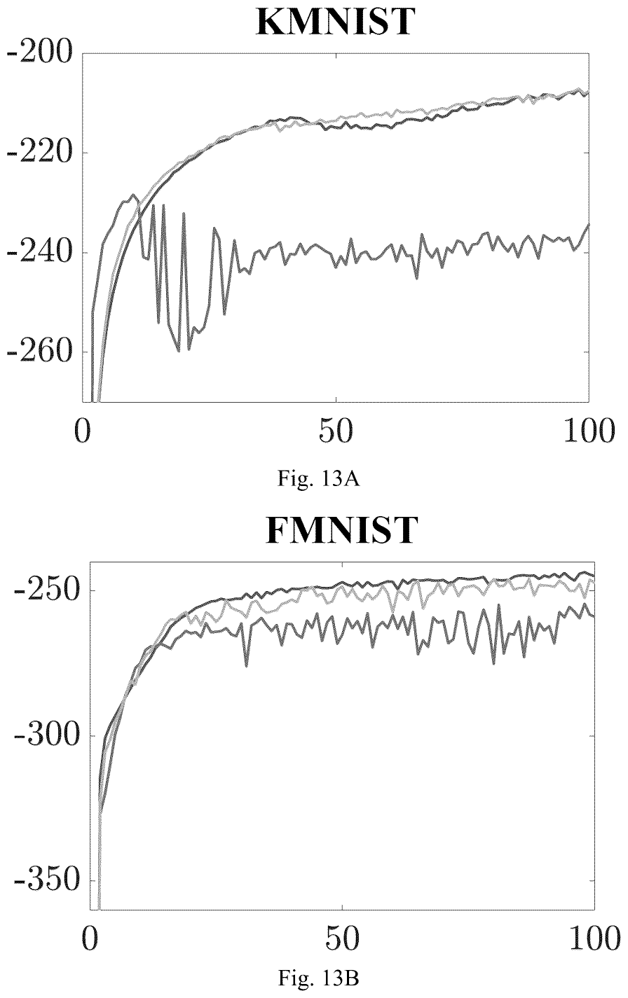

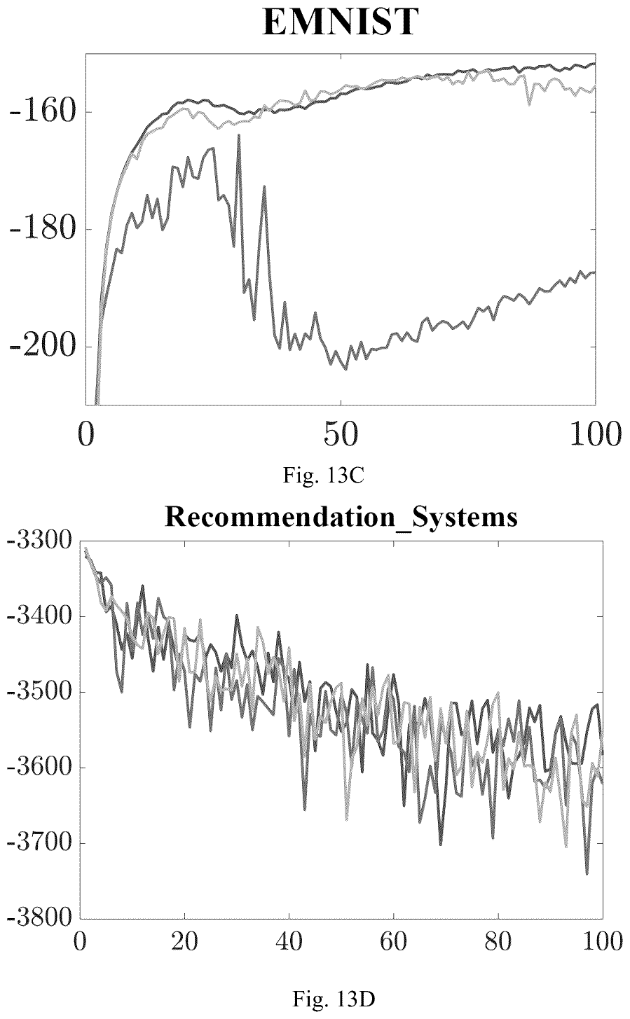

From first principle analysis, the disclosed Boltzmann gradient follower architecture simply implements a different style of stochastic gradient descent. It does not provide the exact same trained weights, but should provide similar solution quality to the end user. The following section numerically analyzes the change resulting from the algorithmic change. Two metrics are used as discussed before: the average log probability of the training samples and classification accuracy. FIG. 12 shows the average log probability of models obtained using different methods (CD-1, CD-10 and the disclosed modified versions to Boltzmann gradient follower) over a period of training with different data sets. Note that the log probability is computationally intractable and thus approximated with AIS as already mentioned above. The result should therefore not be read with too much precision. Indeed, in some data sets (e.g., CIFAR10), the same AIS mechanism fails altogether to produce a finite estimate on the partition function. One example data set (MNIST) is shown in FIG. 12, with others shown in FIG. 13A, FIG. 13B, FIG. 13C, and FIG. 13D. Finally, because the raw data has high frequency noise, a moving average of 10 data points was used to smooth out the data for better clarity. The same legend from FIG. 12 applies to FIG. 13A-FIG. 13D.

As shown, in general, trajectories of log probability increase over time, and often quite substantially. This means the trained models approximate the probability distribution of training data better over time. The exact trajectory, however, is highly variable even under common practices of CD-k with different k values. The disclosed modified algorithm is understandably producing its own trajectory. Compared to CD-10, the difference in trajectory is often less pronounced than that resulting from choosing a small k for expediency. In addition to the uncertainty in the log probability estimate itself, it is noted that beyond a certain point, one could argue that better log probability is simply a result of overfitting. Thus classification errors are shown in Table 4. It is shown that in benchmarks where rounding is applied by the tool, there is no observable difference between common practice and the disclosed algorithm. In the benchmark with a bit more reported precision, the difference is negligible.

TABLE 4

| | RBM | DBN-DDN | RBM | DBN-DDN |
|---|---|---|---|---|
| Datasets | cd-10 | cd-10 | BGF | BGF |
| MNIST | 97% | 99% | 97% | 99% |
| KMNIST | 88% | 93% | 88% | 93% |
| FMNIST | 87% | 90% | 87% | 90% |
| EMNIST | 89% | 95% | 89% | 95% |
| CIFAR10 | 73% | — | 73% | — |
| SmallNORB | 84% | — | 84% | — |
| RC system MAE | 0.7642 | — | 0.7646 | — |
| Anomaly detection AUC | 0.96 | — | 0.96 | — |

The data shown in Table 4 is rounded test accuracy obtained by different types of neural network models for each data set using different algorithms.

Overall, the main takeaway point is that the disclosed system and algorithm comprises small modifications to the common practice algorithm for the convenience of implementation. From a first principle perspective, this is no different than choosing CD-k over, for example, the impractical maximum likelihood learning, or choosing a random k value in CD-k for expediency alone. Empirical observations now suggest that these changes indeed do not affect the efficacy of the learning approach.

### Impact of Noise on Training

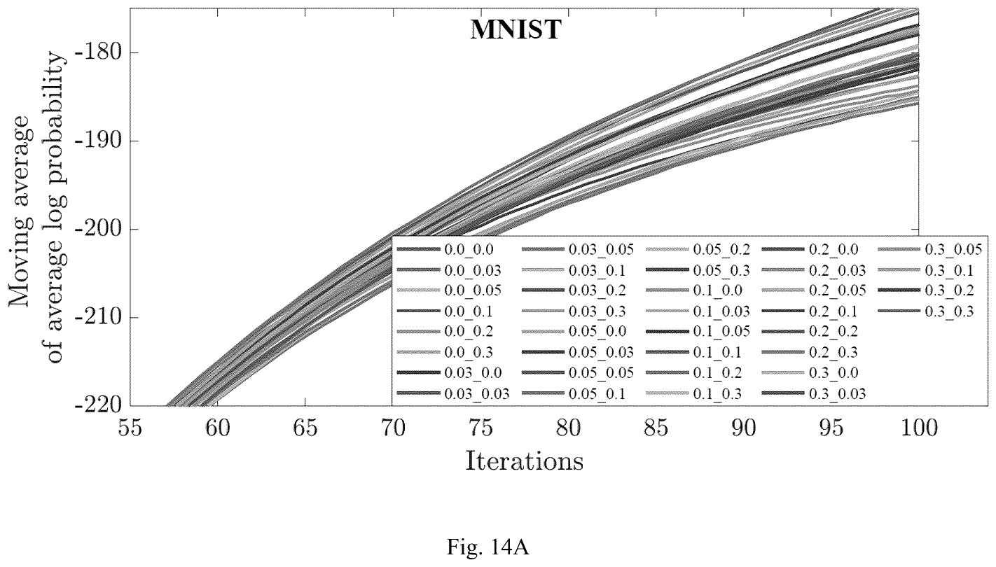

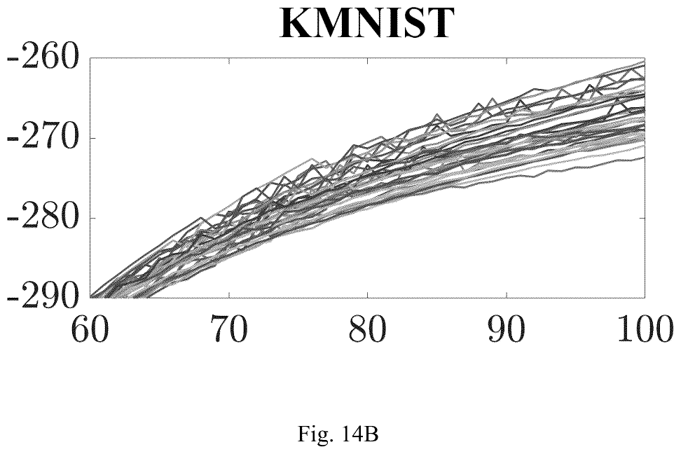

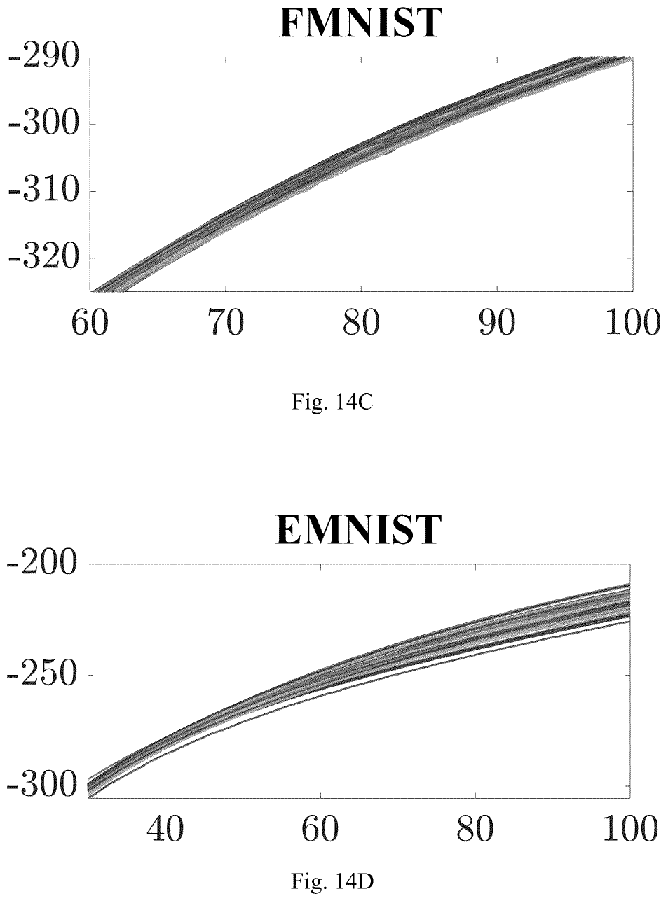

Finally, the impact of noise and variation on solution quality was investigated. Until this point, the results assume the analog hardware suffers from no noise or variation. To simulate process variations and circuit noise, static variation on the resistance of the coupling units and dynamic noises at both nodes and coupling units was injected. The noise and variation were generated by Gaussian distribution with root mean square (RMS) values between 3% and 30%. Different results are thus characterized by a pair (RMSᵥₐᵣᵢₐₜᵢₒₙ, RMSₙₒᵢₛₑ). FIG. 14A, FIG. 14B, FIG. 14C, and FIG. 14D show the same smoothed result of average log probability for 25 combinations for different models. The data are smoothed using a moving average of 10 points.

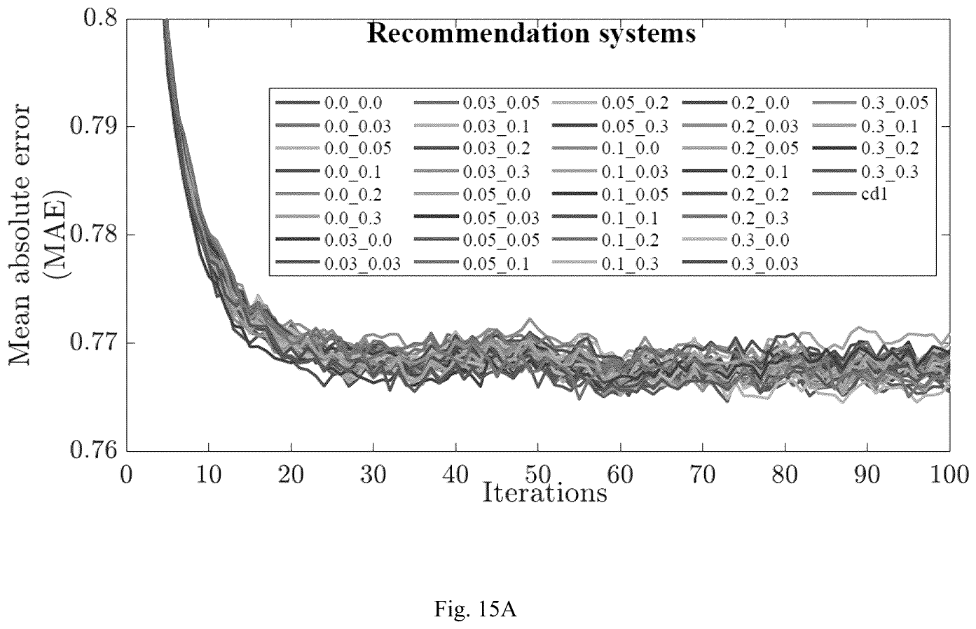

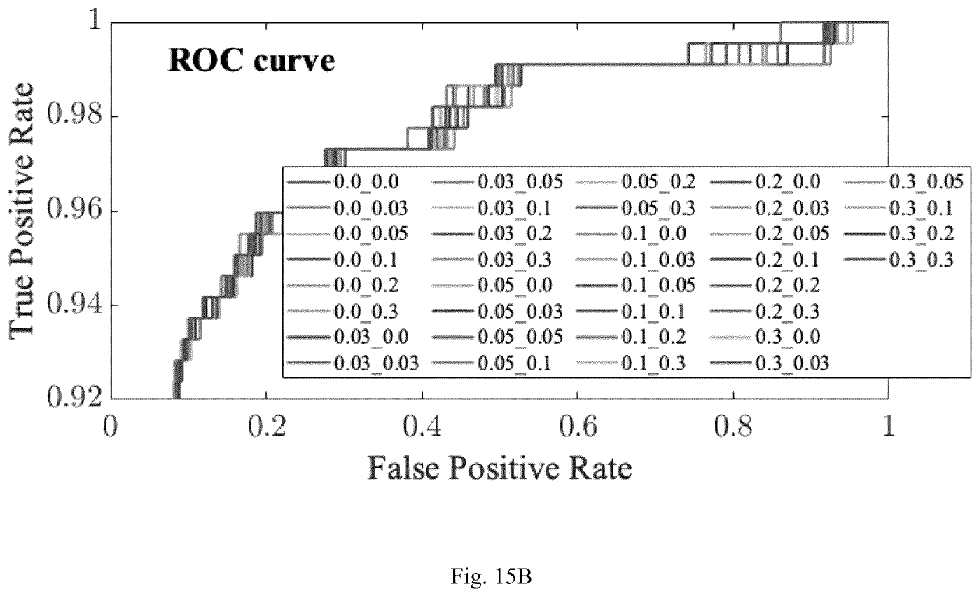

When the combination of noise and variation is not too extreme (e.g., 10% each), the impact on log probability is negligible. In many cases, the loss is smaller than that gained by modifying the algorithm to suit the disclosed Boltzmann gradient follower. But even for the more extreme variation and noise configurations the impact on log probability does not appear significant. And the final inference accuracy is unchanged for all image-based benchmarks. For Recommendation system and anomaly detection benchmarks, the final results do show a little variation as shown in FIG. 15A and FIG. 15B.

To sum up, while the analog circuits are subject to noise, they can competently perform the gradient descent function even in the face of significant noise without affecting the quality of the overall training process.

### Discussion

Overall, experimental analysis of the two architectures provides some evidence that even without new algorithms specifically exploiting the capability of the hardware, substantial performance and energy benefits can be obtained with a very small additional chip footprint. On the other hand, computational substrates such as TPU are clearly much more general-purpose. At this stage, the disclosed analysis does not yet suggest that they are compelling designs per se. However, it shows that there is potential in the general direction for a number of reasons:

First, Ising substrates are already quite useful in accelerating a broad class of optimization problems. They could become even more versatile and widely used in the future. Thus the incremental cost of additional architectural support will become lower still. Second, the disclosed designs may be improved by further research into versatility, performance, reconfigurability, and support for exploiting training set parallelism. Finally, energy-based models have many good qualities but are notoriously expensive to train. With the advent of prototype Ising machines and systems such as the disclosed Boltzmann gradient follower, better algorithms may follow.

### Experiment #2—Bias

Unlike a maximum likelihood (ML) learning algorithm, the contrastive divergence (CD) algorithm is known to be biased. This means that the fixed points of the CD algorithm are not the same as those of the ML algorithm. Although the topic generated numerous publications, in practical terms the issue is insignificant. First, the bias is shown to be small. Second, the ultimate goal of the algorithm is to capture the training data well enough to be useful.

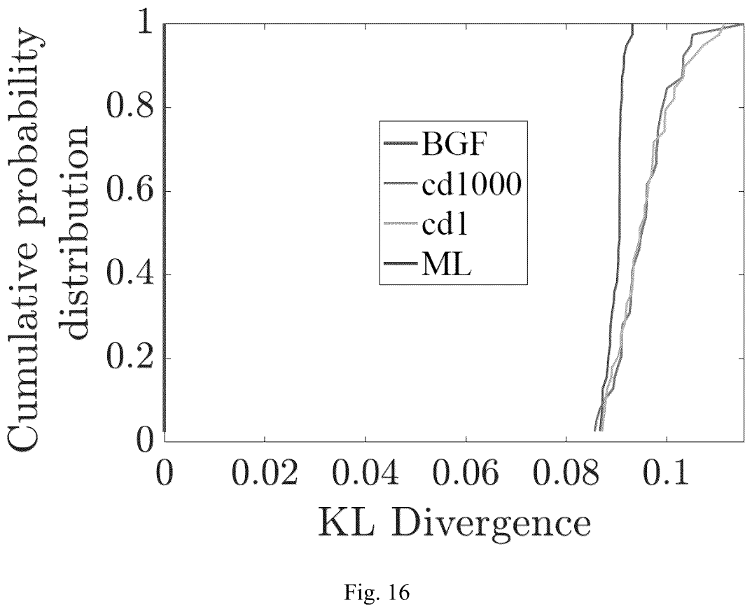

Nevertheless, shown herein are empirical observations of the bias for the disclosed modified training algorithm. For this experiment, the same methodology was used as Carreira-Perpinan and Hinton used in their original investigation. A small enough system size was used such that the ground truth can be obtained via enumeration. The system consisted of 12 visible units and 4 hidden units, all binary. 60 different distributions of 100 training images were generated randomly. ML, CD, and the disclosed training algorithm (BGF) were then all executed for the same 1000 iterations to obtain the weights. Finally, the resulting probability distribution was compared against the ground truth by measuring the KL divergence. Each run of the algorithm produced one KL divergence measure. 400 runs were performed for each algorithm from different random initial conditions. The resulting 400 different measures are plotted as cumulative probability distribution. FIG. 16 shows the result.

First, it is shown that though impractical, ML learning achieves no bias in the final estimates. By contrast, the rest of the algorithms have a fairly similar bias characteristic. This is not surprising because BGF is really a modified CD algorithm. However, because of the inherent speed in exploring the phase space, BGF can be thought of as CD-k with a very large k. As k→∞, CD-k effectively becomes ML. As a result, BGF indeed offers less chance of a larger KL divergence compared to conventional CD-k. Overall, the takeaway point is clear. The disclosed BGF does not create a problem of biased estimation. If anything, it improves the bias characteristic of the commonly used von Neumann algorithm.

The graph of FIG. 16 shows the cumulative probability distribution of KL divergence of CD and BGF training results against ground truth. In other words, every point (x, y) on the curve shows y % of the training distribution has a final KL divergence of x or less from the ground truth.

### CONCLUSION

Ising machines can leverage nature to perform effective computations at a very high speed and energy efficiency. An Ising machine can also be used to perform operations in energy-based models such as restricted Boltzmann machine (RBM) and other derivative algorithms. In this disclosure, two different designs were showcased that augment an Ising substrate with extra circuitry to support RBM training. It was shown that with some small changes, an Ising machine can easily serve as a Gibbs sampler to accelerate part of the RBM algorithm, resulting in about 2× speed improvement and 2.3× energy improvement over a TPU-host. With more substantial changes, the substrate can serve as a Boltzmann sampler while following the gradient to train RBM essentially without any additional host computation. Compared to a TPU host significantly larger in chip area, such a Boltzmann gradient follower can achieve a 29× speedup and 1000× energy savings. With further research, hardware software codesigned nature-based computing systems can be an important new architectural modality.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

### REFERENCES

The following publications are incorporated herein by reference in their entirety:
S. Kirkpatrick, C. D. Gelatt, and M. P. Vecchi, “Optimization by simulated annealing,” Science, vol. 220, no. 4598, pp. 671-680, 1983.
G. Zames, N. Ajlouni, N. Ajlouni, N. Ajlouni, J. Holland, W. Hills, and D. Goldberg, “Genetic algorithms in search, optimization and machine learning,” Information Technology Journal, vol. 3, no. 1, pp. 301-302, 1981.
D. H. Ackley, G. E. Hinton, and T. J. Sejnowski, “A learning algorithm for boltzmann machines,” Cognitive science, vol. 9, no. 1, pp. 147-169, 1985.
A. Narayanan and M. Moore, “Quantum-inspired genetic algorithms,” in Proceedings of IEEE International Conference on Evolutionary Computation, 1996, pp. 61-66.
R. M. Karp, Reducibility among Combinatorial Problems. Boston, MA: Springer US, 1972, pp. 85-103.
A. Lucas, “Ising formulations of many np problems,” Frontiers in Physics, vol. 2, p. 5, 2014.
K. Kim, M.-S. Chang, S. Korenblit, R. Islam, E. E. Edwards, J. K. Freericks, G.-D. Lin, L.-M. Duan, and C. Monroe, “Quantum simulation of frustrated ising spins with trapped ions,” Nature, vol. 465, no. 7298, pp. 590-593, 2010.
N. G. Berloff, M. Silva, K. Kalinin, A. Askitopoulos, J. D. Töpfer, P. Cilibrizzi, W. Langbein, and P. G. Lagoudakis, “Realizing the classical xy hamiltonian in polariton simulators,” Nature materials, vol. 16, no. 11, pp. 1120-1126, 2017.
R. Barends, A. Shabani, L. Lamata, J. Kelly, A. Mezzacapo, U. Las Heras, R. Babbush,
A. G. Fowler, B. Campbell, Y. Chen et al., “Digitized adiabatic quantum computing with a superconducting circuit,” Nature, vol. 534, no. 7606, pp. 222-226, 2016.
M. Yamaoka, C. Yoshimura, M. Hayashi, T. Okuyama, H. Aoki, and H. Mizuno, “A 20k-spin ising chip to solve combinatorial optimization problems with cmos annealing,” IEEE Journal of Solid-State Circuits, vol. 51, no. 1, pp. 303-309, 2015.
P. I. Bunyk, E. M. Hoskinson, M. W. Johnson, E. Tolkacheva, F. Altomare, A. J. Berkley, R. Harris, J. P. Hilton, T. Lanting, A. J. Przybysz et al., “Architectural considerations in the design of a superconducting quantum annealing processor,” IEEE Transactions on Applied Superconductivity, vol. 24, no. 4, pp. 1-10, 2014.
A. D. King, J. Carrasquilla, J. Raymond, I. Ozfidan, E. Andriyash, A. Berkley, M. Reis, T. Lanting, R. Harris, F. Altomare et al., “Observation of topological phenomena in a programmable lattice of 1,800 qubits,” Nature, vol. 560, no. 7719, pp. 456-460, 2018.
F. Böhm, G. Verschaffelt, and G. Van der Sande, “A poor man's coherent ising machine based on opto-electronic feedback systems for solving optimization problems,” Nature communications, vol. 10, no. 1, pp. 1-9, 2019.
R. Hamerly, A. Sludds, L. Bernstein, M. Prabhu, C. Roques-Carmes, J. Carolan, Y. Yamamoto, M. Soljacic, and D. Englund, “Towards large-scale photonic neural-network accelerators,” in 2019 IEEE International Electron Devices Meeting (IEDM). IEEE, 2019, pp. 22-8.
D. Pierangeli, G. Marcucci, and C. Conti, “Large-scale photonic ising machine by spatial light modulation,” Physical review letters, vol. 122, no. 21, p. 213902, 2019.
R. Harris, M. W. Johnson, T. Lanting, A. J. Berkley, J. Johansson, P. Bunyk, E. Tolkacheva, E. Ladizinsky, N. Ladizinsky, T. Oh, F. Cioata, I. Perminov, P. Spear, C. Enderud, C. Rich, S. Uchaikin, M. C. Thom, E. M. Chapple, J. Wang, B. Wilson, M. H. S. Amin, N. Dickson, K. Karimi, B. Macready, C. J. S. Truncik, and G. Rose, “Experimental investigation of an eight-qubit unit cell in a superconducting optimization processor,” Phys. Rev. B, vol. 82, p. 024511, July 2010.
T. Inagaki, Y. Haribara, K. Igarashi, T. Sonobe, S. Tamate, T. Honjo, A. Marandi, P. L. McMahon, T. Umeki, K. Enbutsu et al., “A coherent ising machine for 2000-node optimization problems,” Science, vol. 354, no. 6312, pp. 603-606, 2016.
R. Afoakwa, Y. Zhang, U. K. R. Vengalam, Z. Ignjatovic, and Michael, “Brim: Bistable resistively coupled ising machine,” 2021.
S. Boixo, T. F. Rønnow, S. V. Isakov, Z. Wang, D. Wecker, D. A. Lidar, J. M. Martinis, and M. Troyer, “Evidence for quantum annealing with more than one hundred qubits,” Nature physics, vol. 10, no. 3, pp. 218-224, 2014.
R. Hamerly, T. Inagaki, P. L. McMahon, D. Venturelli, A. Marandi, T. Onodera, E. Ng, C. Langrock, K. Inaba, T. Honjo et al., “Experimental investigation of performance differences between coherent ising machines and a quantum annealer,” Science advances, vol. 5, no. 5, p. eaau0823, 2019.
R. Hamerly, T. Inagaki, P. L. McMahon, D. Venturelli, A. Marandi, T. Onodera, E. Ng,
C. Langrock, K. Inaba et al., “Scaling advantages of all-to-all connectivity in physical annealers: the coherent ising machine vs. d-wave 2000q,” arXiv:arXiv: 1807.00089, 2018.
Y. Yamamoto, K. Aihara, T. Leleu, K.-i. Kawarabayashi, S. Kako, M. Fejer, K. Inoue, and H. Takesue, “Coherent ising machines—optical neural networks operating at the quantum limit,” npj Quantum Information, vol. 3, no. 1, pp. 1-15, 2017.
P. L. McMahon, A. Marandi, Y. Haribara, R. Hamerly, C. Langrock, S. Tamate, T. Inagaki, H. Takesue, S. Utsunomiya, K. Aihara, R. L. Byer, M. M. Fejer, H. Mabuchi, and Y. Yamamoto, “A fully programmable 100-spin coherent ising machine with all-to-all connections,” Science, vol. 354, no. 6312, pp. 614-617, 2016.
K. Takata, A. Marandi, R. Hamerly, Y. Haribara, D. Maruo, S. Tamate, H. Sakaguchi, S. Utsunomiya, and Y. Yamamoto, “A 16-bit coherent ising machine for one-dimensional ring and cubic graph problems,” Scientific Reports, vol. 6, no. 1, p. 34089, 2016.
F. Böhm, G. Verschaffelt, and G. Van der Sande, “A poor man's coherent ising machine based on opto-electronic feedback systems for solving optimization problems,” Nature Communications, vol. 10, no. 1, p. 3538, 2019.
Y. Takeda, S. Tamate, Y. Yamamoto, H. Takesue, T. Inagaki, and S. Utsunomiya, “Boltzmann sampling for an XY model using a non-degenerate optical parametric oscillator network,” Quantum Science and Technology, vol. 3, no. 1, p. 014004, November 2017.
K. Cho, A. Ilin, and T. Raiko, “Improved learning of gaussian-bernoulli restricted boltzmann machines,” in International conference on artificial neural networks. Springer, 2011, pp. 10-17.
Y. LeCun, S. Chopra, M. Ranzato, and F.-J. Huang, “Energy-based models in document recognition and computer vision,” in Ninth International Conference on Document Analysis and Recognition (ICDAR 2007), vol. 1. IEEE, 2007, pp. 337-341.
S. Ding, J. Zhang, N. Zhang, and Y. Hou, “Boltzmann machine and its applications in image recognition,” in Intelligent Information Processing VIII, Z. Shi, S. Vadera, and G. Li, Eds. Cham: Springer International Publishing, 2016, pp. 108-118.
G. E. Dahl, M. Ranzato, A.r. Mohamed, and G. Hinton, “Phone recognition with the mean-covariance restricted boltzmann machine,” in Proceedings of the 23rd International Conference on Neural Information Processing Systems—Volume 1, ser. NIPS′10. Red Hook, NY, USA: Curran Associates Inc., 2010, p. 469-477.
R. D. Hjelm, V. D. Calhoun, R. Salakhutdinov, E. A. Allen, T. Adali, and S. M. Plis, “Restricted boltzmann machines for neuroimaging: An application in identifying intrinsic networks,” NeuroImage, vol. 96, pp. 245-260, 2014.
A. Al-Waisy, M. A. Mohammed, S. Al-Fahdawi, M. Maashi, B. Garcia-Zapirain, K. H. Abdulkareem, S. Mostafa, N. M. Kumar, and D. N. Le, “Covid-deepnet: Hybrid multimodal deep learning system for improving covid-19 pneumonia detection in chest x-ray images,” CMC-COMPUTERS MATERIALS & CONTINUA, vol. 67, no. 2, pp. 2409-2429, 2021.
Q. Zhang, Y. Xiao, W. Dai, J. Suo, C. Wang, J. Shi, and H. Zheng, “Deep learning based classification of breast tumors with shear-wave elastography,” Ultrasonics, vol. 72, pp. 150-157, 2016.
R. Salakhutdinov and G. Hinton, “Deep boltzmann machines,” in Artificial intelligence and statistics. PMLR, 2009, pp. 448-455.
H. Wang, Y. Cai, and L. Chen, “A vehicle detection algorithm based on deep belief network,” The scientific world journal, vol. 2014, 2014.
A. M. Abdel-Zaher and A. M. Eldeib, “Breast cancer classification using deep belief networks,” Expert Systems with Applications, vol. 46, pp. 139-144, 2016.
R. Salakhutdinov, A. Mnih, and G. Hinton, “Restricted boltzmann machines for collaborative filtering,” in Proceedings of the 24th international conference on Machine learning, 2007, pp. 791-798.
A. Gouveia and M. Correia, “A systematic approach for the application of restricted boltzmann machines in network intrusion detection,” in International Work-Conference on Artificial Neural Networks. Springer, 2017, pp. 432-446.
U. Fiore, F. Palmieri, A. Castiglione, and A. De Santis, “Network anomaly detection with the restricted boltzmann machine,” Neurocomputing, vol. 122, pp. 13-23, 2013.
Y. Wang, Z. Pan, X. Yuan, C. Yang, and W. Gui, “A novel deep learning based fault diagnosis approach for chemical process with extended deep belief network,” ISA transactions, vol. 96, pp. 457-467, 2020.
J. Xie, G. Du, C. Shen, N. Chen, L. Chen, and Z. Zhu, “An end-to-end model based on improved adaptive deep belief network and its application to bearing fault diagnosis,” IEEE Access, vol. 6, pp. 63 584-63 596, 2018.
N. Srivastava, R. R. Salakhutdinov, and G. E. Hinton, “Modeling documents with deep boltzmann machines,” arXiv: 1309.6865, 2013.
M. Fatemi and M. Safayani, “Joint sentiment/topic modeling on text data using a boosted restricted boltzmann machine,” Multimedia Tools and Applications, vol. 78, no. 15, pp. 20 637-20 653, 2019.
G. Hinton and R. Salakhutdinov, “Discovering binary codes for documents by learning deep generative models,” Topics in Cognitive Science, vol. 3, no. 1, pp. 74-91, 2011.
J. Hernandez and A. G. Abad, “Learning from multivariate discrete sequential data using a restricted boltzmann machine model,” in 2018 IEEE 1st Colombian Conference on Applications in Computational Intelligence (ColCACI). IEEE, 2018, pp. 1-6.
H. Larochelle, Y. Bengio, J. Louradour, and P. Lamblin, “Exploring strategies for training deep neural networks.” Journal of machine learning research, vol. 10, no. 1, 2009.
D. Erhan, A. Courville, Y. Bengio, and P. Vincent, “Why does unsupervised pre-training help deep learning?” in Proceedings of the thirteenth international conference on artificial intelligence and statistics. JMLR Workshop and Conference Proceedings, 2010, pp. 201-208.
Y. Hua, J. Guo, and H. Zhao, “Deep belief networks and deep learning,” in Proceedings of 2015 International Conference on Intelligent Computing and Internet of Things. IEEE, 2015, pp. 1-4.
E. Qin, A. Samajdar, H. Kwon, V. Nadella, S. Srinivasan, D. Das, B. Kaul, and T. Krishna, “Sigma: A sparse and irregular gemm accelerator with flexible interconnects for dnn training,” in 2020 IEEE International Symposium on High Performance Computer Architecture (HPCA), 2020, pp. 58-70.
S. Levantino, G. Marzin, and C. Samori, “An adaptive pre-distortion technique to mitigate the dtc nonlinearity in digital plls,” IEEE Journal of Solid-State Circuits, vol. 49, no. 8, pp. 1762-1772, 2014.
M. R. Li, C. H. Yang, and Y. L. Ueng, “A 5.28-gb/s ldpc decoder with time-domain signal processing for ieee 802.15. 3c applications,” IEEE Journal of Solid-State Circuits, vol. 52, no. 2, pp. 592-604, 2016.
D. Miyashita, R. Yamaki, K. Hashiyoshi, H. Kobayashi, S. Kousai, Y. Oowaki, and Y. Unekawa, “An ldpc decoder with time-domain analog and digital mixed-signal processing,” IEEE Journal of Solid-State Circuits, vol. 49, no. 1, pp. 73-83, 2013.
K. Madani, P. Garda, E. Belhaire, and F. Devos, “Two analog counters for neural network implementation,” IEEE Journal of Solid-State Circuits, vol. 26, no. 7, pp. 966-974, 1991.
N. P. Jouppi, C. Young, N. Patil, D. Patterson, G. Agrawal, R. Bajwa, S. Bates, S. Bhatia, N. Boden, A. Borchers et al., “In-datacenter performance analysis of a tensor processing unit,” in Proceedings of the 44th Annual International Symposium on Computer Architecture, 2017, pp. 1-12.
L. Deng, “The mnist database of handwritten digit images for machine learning research [best of the web],” IEEE Signal Processing Magazine, vol. 29, no. 6, pp. 141-142, 2012.
T. Clanuwat, M. Bober-Irizar, A. Kitamoto, A. Lamb, K. Yamamoto, and D. Ha, “Deep learning for classical japanese literature,” arXiv: 1812.01718, 2018.
H. Xiao, K. Rasul, and R. Vollgraf, “Fashion-mnist: a novel image dataset for benchmarking machine learning algorithms,” arXiv: 1708.07747, 2017.
G. Cohen, S. Afshar, J. Tapson, and A. Van Schaik, “Emnist: Extending mnist to handwritten letters,” in 2017 International Joint Conference on Neural Networks (IJCNN). IEEE, 2017, pp. 2921-2926.
A. Krizhevsky, G. Hinton et al., “Learning multiple layers of features from tiny images,” 2009.
Y. LeCun, F. J. Huang, and L. Bottou, “Learning methods for generic object recognition with invariance to pose and lighting,” in Proceedings of the 2004 IEEE Computer Society Conference on Computer Vision and Pattern Recognition, 2004. CVPR 2004., vol. 2. IEEE, 2004, pp. II-104.
A. Coates, A. Ng, and H. Lee, “An analysis of single-layer networks in unsupervised feature learning,” in Proceedings of the fourteenth international conference on artificial intelligence and statistics. JMLR Workshop and Conference Proceedings, 2011, pp. 215-223.
S. Verma, P. Patel, and A. Majumdar, “Collaborative filtering with label consistent restricted boltzmann machine,” in 2017 Ninth International Conference on Advances in Pattern Recognition (ICAPR). IEEE, 2017, pp. 1-6.
A. Pumsirirat and L. Yan, “Credit card fraud detection using deep learning based on auto-encoder and restricted boltzmann machine,” International Journal of Advanced Computer Science and Applications, vol. 9, no. 1, 2018.
F. M. Harper and J. A. Konstan, “The movielens datasets: History and context,” Acm transactions on interactive intelligent systems (tiis), vol. 5, no. 4, pp. 1-19, 2015.
R. Salakhutdinov and I. Murray, “On the quantitative analysis of deep belief networks,” in Proceedings of the 25th international conference on Machine learning, 2008, pp. 872-879.
W. Li, P. Xu, Y. Zhao, H. Li, Y. Xie, and Y. Lin, “Timely: Pushing data movements and interfaces in pim accelerators towards local and in time domain,” in 2020 ACM IEEE 47th Annual International Symposium on Computer Architecture (ISCA). IEEE, 2020, pp. 832-845.
X. He, S. Pal, A. Amarnath, S. Feng, D.-H. Park, A. Rovinski, H. Ye, Y. Chen, R. Dreslinski, and T. Mudge, “Sparse-tpu: Adapting systolic arrays for sparse matrices,” in Proceedings of the 34th ACM International Conference on Supercomputing, 2020, pp. 1-12.
M. A. Carreira-Perpinan and G. Hinton, “On contrastive divergence learning,” in International workshop on artificial intelligence and statistics. PMLR, 2005, pp. 33-40.

1. A bistable resistively-coupled system, comprising:
a plurality of visible nodes;
a plurality of hidden nodes; and
a plurality of coupling elements, each electrically connected to a visible node of the plurality of visible nodes and a hidden node of the plurality of hidden nodes;
wherein each of the plurality of coupling elements comprises a programmable resistor.

2. The system of claim 1, wherein each of the plurality of coupling elements comprises two programmable resistors.

3. The system of claim 1, wherein each programmable resistor comprises a field effect transistor having a source, a gate, and a drain, with a gate capacitor connected between the source and the gate.

4. The system of claim 1, wherein each of the plurality of coupling elements comprises an analog counter having an overflow and an underflow signal, the overflow signal configured to increase a value of the programmable resistor and the underflow signal configured to decrease the value of the programmable resistor.

5. The system of claim 1, wherein at least one node of the plurality of visible nodes or the plurality of hidden nodes comprises a sigmoid element, the sigmoid element comprising an inverter having an input, an output, and a loading resistor connected between the output and a common mode reference.

6. The system of claim 1, wherein at least one node of the plurality of visible nodes or the plurality of hidden nodes comprises a random noise generator, the random noise generator comprising a binary random number generator having an output, and a low-pass filter connected to the output.

7. The system of claim 6, further comprising a comparator having first and second inputs, the first input connected to an output of a sigmoid element and the second input connected to the filtered output of the binary random number generator.

8. The system of claim 1, wherein at least one node of the plurality of visible nodes or the plurality of hidden nodes comprises a buffer or a capacitor and a feedback unit connected across the capacitor configured to make a voltage across the capacitor bistable.

9. (canceled)

10. A coupling device for connecting first and second nodes in network, comprising:
inverted and non-inverted inputs;
first and second field effect transistors, each having a drain, a gate, and a source, the drain of the first field effect transistor connected to the non-inverted input and the drain of the second field effect transistor connected to the inverting input;
first and second gate capacitors connected between the gate and source of the first and second field effect transistors, respectively;
a summing output connected to the sources of the first and second field effect transistors; and
a voltage adjusting element connected to the gates of the first and second field effect transistors, configured to adjust the gate voltages of the first and second field effect transistors in response to a control signal.

11. The coupling device of claim 10, wherein the voltage adjusting element comprises an analog counter.

12. The coupling device of claim 10, further comprising at least one current source switchably connected to a gate of the first or second field effect transistor.

13. The coupling device of claim 10, further comprising four current sources, with one switchably connected to each of the gates of the first and second field effect transistors and connected to a positive voltage or a ground.

14. The coupling device of claim 11, wherein the voltage adjusting element further comprises overflow and underflow outputs of the analog counter configured to increase or decrease the amount of charge on the first and second gate capacitors.

15. The coupling device of claim 10, wherein the first and second field effect transistors are N-channel field effect transistors.

16. A method of training a bistable, resistively coupled system, comprising:
initializing a set of weighting elements and a set of biasing elements in the bistable, resistively coupled system;
initializing a set of visible nodes of the bistable resistively coupled system to a first set of initial values;
clamping the set of visible nodes to the first set of initial values for a period of time, and allowing a set of hidden nodes to settle at a first set of hidden values;
incrementing a counter of at least one weighting element based on the product of the first set of initial values and the first set of hidden values initializing a set of hidden nodes of the bistable resistively coupled system to a random set of values selected from a table of hidden values;
annealing visible and hidden nodes for a second period of time;
decrementing the counter of at least one weighting element based on the annealed values of the visible and hidden nodes;
incrementing or decrementing a weighting value of the at least one weighting element if the counter of the at least one weighting element overflows or underflows; and
repeating the steps from the step of initializing the set of visible nodes for a programmable number of learning steps.

17. The method of claim 16, wherein the set of values used to initialize the set of hidden nodes is obtained from the corresponding set of hidden values from a previous annealing step.

18. The method of claim 16, further comprising the step of reading coupling values from the system using at least one analog to digital converter.

19. The method of claim 16, wherein the period of time is in a range of 1 nanosecond or less.

20. The method of claim 16, wherein the second period of time is in a range of 1 nanosecond or less.

21. The method of claim 16, further comprising the step of storing the annealed values of the hidden nodes in the table of hidden values after annealing.
